(19) United States
(12) Patent Application Publication
(10) Pub. No.: US 2003/0078949 A1
(43) Pub. Date: Apr. 24, 2003

(54) Automatic generation of forms with input validation

(76) Inventors: Bernhard J. Scholz, Ballston Lake, NY (US); Brian T. Murren, Clifton Park, NY (US); Richard B. Arthur, Ballston Spa, NY (US); Walter V. Dixon,III, Delanson, NY (US)

Correspondence Address: LEE & HAYES PLLC, SUITE 500, 421 W RIVERSIDE, SPOKANE, WA, 99201

(21) Appl. No.: 09/845,751

(22) Filed: Apr. 30, 2001

(51) Int. Cl. G06F 15/00

(52) U.S. Cl. 707/505; 707/507

(57) ABSTRACT

An initial form definition includes one or more custom tags identifying the input field(s) for a form and restriction(s) on inputs to those field(s). An output form definition is generated based on the initial form definition, the output form definition including each of these one or more custom tags as converted to another tag format as well as the validation code corresponding to the indicated restriction(s) on input.

### TECHNICAL FIELD

The present invention is directed to form generation, and more particularly to automatic generation of forms with input validation.

### BACKGROUND

Computer technology is ever-advancing, resulting in increasingly powerful computers becoming available. The field of computer programming has seized upon these advances and is continually developing increasingly powerful computer programs having a wide range of functionality. Unfortunately, these increasingly powerful computer programs are becoming increasingly large and complex, resulting in significant programmer-time being used to generate and test the programs.

One specific problem found in developing computer programs is the validation of user input. Many computer programs use different forms to allow a user to input data to the program (e.g., a form to allow input of a user ID and password for logging into a program, a form for inputting search terms for accessing a database, etc.). Often times the programmer desires to place restrictions on what data the user can input to these forms. For example, certain data may be required (e.g., a user id and password) or the input data may be required to have a minimum number of characters.

Typically, user input is validated by the programmer manually writing code to verify that the desired restrictions are not violated. Developing and testing such code requires additional time and effort on the part of the programmer, resulting in increased cost and/or delayed program-availability. It would thus be desirable to have a technique to validate inputs to forms while at the same reducing the overall expense and time of developing the forms.

### SUMMARY

Automatic generation of forms with input validation is described herein. An initial form definition includes one or more custom tags identifying the input field(s) for the form and restriction(s) on inputs to those field(s). An output form definition is generated based on the initial form definition, the output form definition including each of these one or more custom tags as converted to another tag format as well as the validation code corresponding to the indicated restriction(s) on input.

### BRIEF DESCRIPTION OF THE DRAWINGS

FIG. 1 illustrates a network system that implements a server application architecture that may be tailored to various domains.

FIG. 2 is a block diagram of the application architecture.

FIG. 3 is a flow diagram illustrating a general operation of the application architecture when handling client requests.

FIG. 4 is a block diagram of an exemplary execution model configured as an asset catalog program that allows a user to view, create, and modify information relating to assets stored in an electronic catalog.

FIG. 5 is a flow diagram of a process for executing the asset catalog program.

FIG. 6 is a block diagram of the program controller used in the execution model of FIG. 4.

FIG. 7 illustrates an example form having multiple data input fields.

FIG. 8 illustrates an exemplary automatic form generation with input validation system.

FIG. 9 is a flowchart illustrating an exemplary process for automatically generating forms with input validation.

FIG. 10 illustrates an exemplary interaction that can be analyzed for identification of restrictions on input fields as well as for identification of fields themselves.

FIG. 11 is a flowchart illustrating an exemplary process for automatically identifying fields and field restrictions for forms.

FIG. 12 is a flowchart illustrating an exemplary process for automatically identifying field restrictions for forms.

The same reference numbers are used throughout the figures to reference like components and features.

### DETAILED DESCRIPTION

A software architecture specifies distinct layers or modules that interact with each other according to a well-defined specification to facilitate efficient and timely construction of business processes and server applications for many diverse domains. Examples of possible domains include asset management, leasing and lending, insurance, financial management, asset repair, inventory tracking, other business-oriented domains, and so forth. The architecture implements a common infrastructure and problem-solving logic model using a domain framework. By partitioning the software into a hierarchy of layers, individual modules may be readily “swapped out” and replaced by other modules that effectively adapt the architecture to different domains.

With this architecture, developers are able to create different software applications very rapidly by leveraging the common infrastructure. New business models can be addressed, for example, by creating new domain frameworks that “plug” into the architecture. This allows developers to modify only a portion of the architecture to construct new applications, resulting in a fraction of the effort that would be needed to build entirely new applications if all elements of the application were to be constructed.

### EXEMPLARY SYSTEM

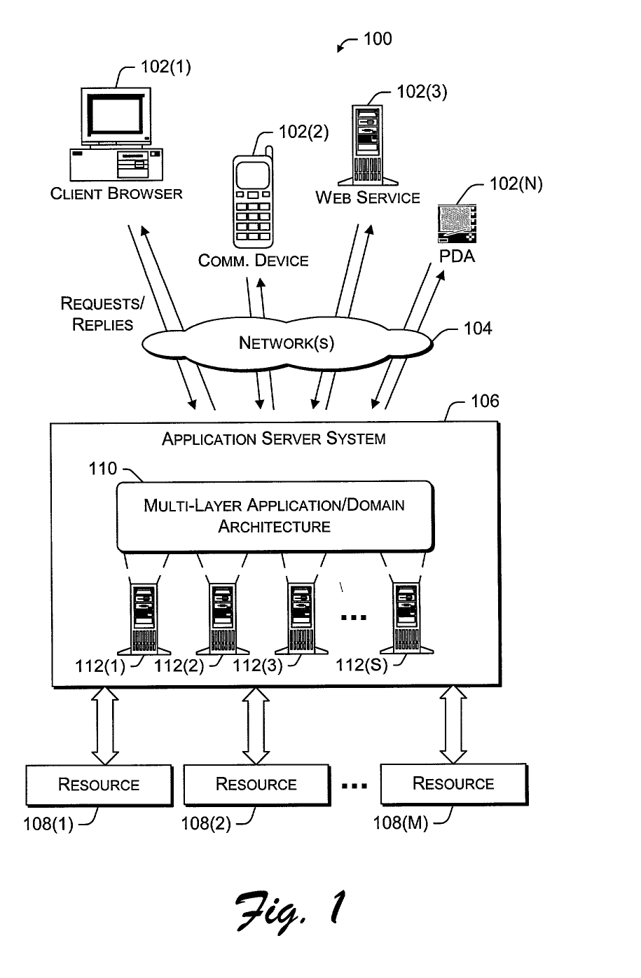

FIG. 1 shows a network system 100 in which the tiered software architecture may be implemented. The system 100 includes multiple clients 102(1), 102(2), 102(3), . . . , 102(N) that submit requests via one or more networks 104 to an application server system 106. Upon receiving the requests, the server system 106 processes the requests and returns replies to the clients 102 over the network(s) 104. In some situations, the server system 106 may access one or more resources 108(1), 108(2),., 108(M) to assist in preparing the replies.

The clients 102 may be implemented in a number of ways, including as personal computers (e.g., desktop, laptop, palmtop, etc.), communications devices, personal digital assistants (PDAs), entertainment devices (e.g., Web-enabled televisions, gaming consoles, etc.), other servers, and so forth. The clients 102 submit their requests using a number of different formats and protocols, depending upon the type of client and the network 104 interfacing a client and the server 106.

The network 104 may be implemented by one or more different types of networks (e.g., Internet, local area network, wide area network, telephone, etc.), including wire-based technologies (e.g., telephone line, cable, etc.) and/or wireless technologies (e.g., RF, cellular, microwave, IR, wireless personal area network, etc.). The network 104 can be configured to support any number of different protocols, including HTTP (HyperText Transport Protocol), TCP/IP (Transmission Control Protocol/Internet Protocol), WAP (Wireless Application Protocol), and so on.

The server system 106 implements a multi-layer software architecture 110 that is tailored to various problem domains, such as asset management domains, financial domains, asset lending domains, insurance domains, and so forth. The multi-layer architecture 110 resides and executes on one or more computers, as represented by server computers 112(1), 112(2), 112(3), . . . , 112(S). The tiered architecture 110 may be adapted to handle many different types of client devices 102, as well as new types as they become available. Additionally, the architecture 110 may be readily configured to accommodate new or different resources 108.

The server computers 112 are configured as general computing devices having processing units, one or more types of memory (e.g., RAM, ROM, disk, RAID storage, etc.), input and output devices, and a busing architecture to interconnect the components. As one possible implementation, the servers 112 may be interconnected via other internal networks to form clusters or a server farm, wherein different sets of servers support different layers or modules of the architecture 110. The servers may or may not reside within a similar location, with the software being distributed across the various machines. Various layers of the architecture 110 may be executed on one or more servers. As an alternative implementation, the architecture 110 may be implemented on single computer, such as a mainframe computer or a powerful server computer, rather than the multiple servers as illustrated.

The resources 108 are representative of any number of different types of resources. Examples of resources include databases, websites, legacy financial systems, electronic trading networks, auction sites, and so forth. The resources 108 may reside with the server system 106, or be located remotely. Access to the resources may be supported by any number of different technologies, networks, protocols, and the like.

### GENERAL ARCHITECTURE

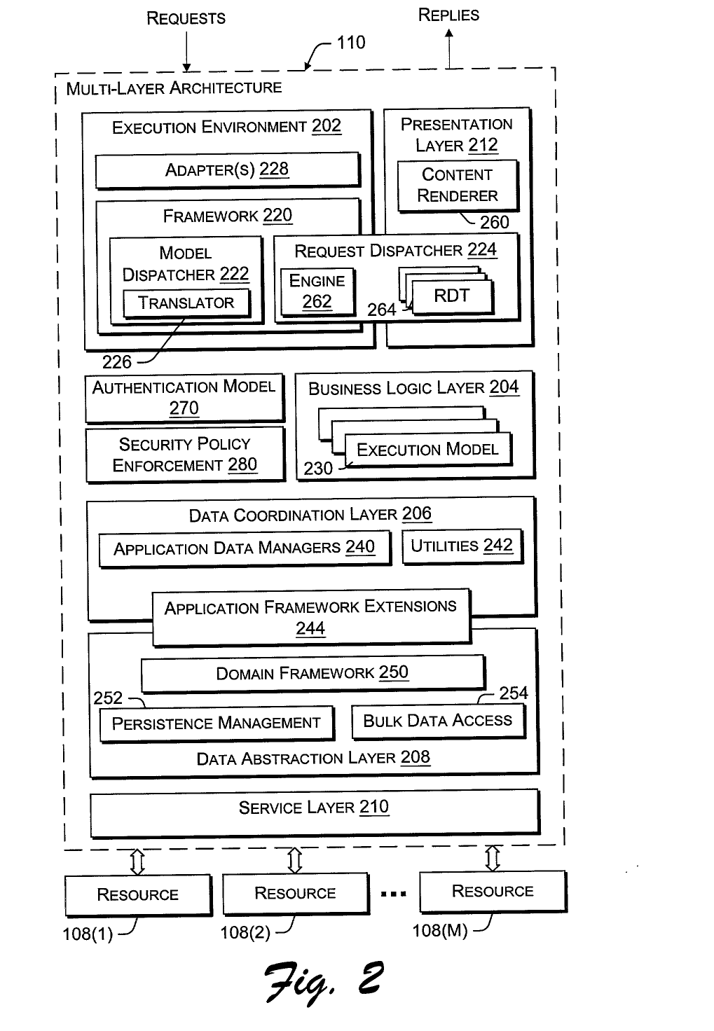

FIG. 2 illustrates one exemplary implementation of the multi-layer architecture 110 that is configured as a server application for a business-oriented domain. The architecture is logically partitioned into multiple layers to promote flexibility in adapting the architecture to different problem domains. Generally, the architecture 110 includes an execution environment layer 202, a business logic layer 204, a data coordination layer 206, a data abstraction layer 208, a service layer 210, and a presentation layer 212. The layers are illustrated vertically to convey an understanding as to how requests are received and handled by the various layers.

Client requests are received at the execution environment 202 and passed to the business logic layer 204 for processing according to the specific business application. As the business logic layer 204 desires information to fulfill the requests, the data coordination layer 206, data abstraction layer 208, and service layer 210 facilitate extraction of the information from the external resources 108. When a reply is completed, it is passed to the execution environment 202 and presentation layer 212 for serving back to the requesting client.

The architecture 110 can be readily modified to (1) implement different applications for different domains by plugging in the appropriate business logic in the business logic layer 204, (2) support different client devices by configuring suitable modules in the execution environment 202 and presentation layer 212, and (3) extract information from diverse resources by inserting the appropriate modules in the data abstraction layer 208 and service layer 210. The partitioned nature of the architecture allows these modifications to be made independently of one another. As a result, the architecture 110 can be adapted to many different domains by interchanging one or more modules in selected layers without having to reconstruct entire application solutions for those different domains.

The execution environment 202 contains an execution infrastructure to handle requests from clients. In one sense, the execution environment acts as a container into which the business logic layer 204 may be inserted. The execution environment 202 provides the interfacing between the client devices and the business logic layer 204 so that the business logic layer 204 need not understand how to communicate directly with the client devices.

The execution environment 202 includes a framework 220 that receives the client requests and routes the requests to the appropriate business logic for processing. After the business logic generates replies, the framework 220 interacts with the presentation layer 212 to prepare the replies for return to the clients in a format and protocol suitable for presentation on the clients.

The framework 220 is composed of a model dispatcher 222 and a request dispatcher 224. The model dispatcher 222 routes client requests to the appropriate business logic in the business logic layer 204. It may include a translator 226 to translate the requests into an appropriate form to be processed by the business logic. For instance, the translator 226 may extract data or other information from the requests and pass in this raw data to the business logic layer 204 for processing. The request dispatcher 224 formulates the replies in a way that can be sent and presented at the client. Notice that the request dispatcher is illustrated as bridging the execution environment 202 and the presentation layer 212 to convey the understanding that, in the described implementation, the execution environment and the presentation layer share in the tasks of structuring replies for return and presentation at the clients.

One or more adapters 228 may be included in the execution environment layer 202 to interface the framework 220 with various client types. As an example, one adapter may be provided to receive requests from a communications device using WAP, while another adapter may be configured to receive requests from a client browser using HTTP, while a third adapter is configured to receive requests from a messaging service using a messaging protocol.

The business logic layer 204 contains the business logic of an application that processes client requests. Generally speaking, the business logic layer contains problem-solving logic that produces solutions for a particular problem domain. In this example, the problem domain is a commerce-oriented problem domain (e.g., asset lending, asset management, insurance, etc.), although the architecture 110 can be implemented in non-business contexts. The logic in the logic layer is therefore application-specific and hence, is written on a per-application basis for a given domain.

In the illustrated implementation, the business logic in the business logic layer 204 is constructed as one or more execution models 230 that define how computer programs process the client requests received by the application. The execution models 230 may be constructed in a variety of ways. One exemplary execution model employs an interaction-based definition in which computer programs are individually defined by a series of one or more interaction definitions based on a request-response model. Each interaction definition includes one or more command definitions and view definitions. A command definition defines a command whose functionality may be represented by an object that has various attributes and that provides the behavior for that command. A view definition defines a view that provides a response to a request.

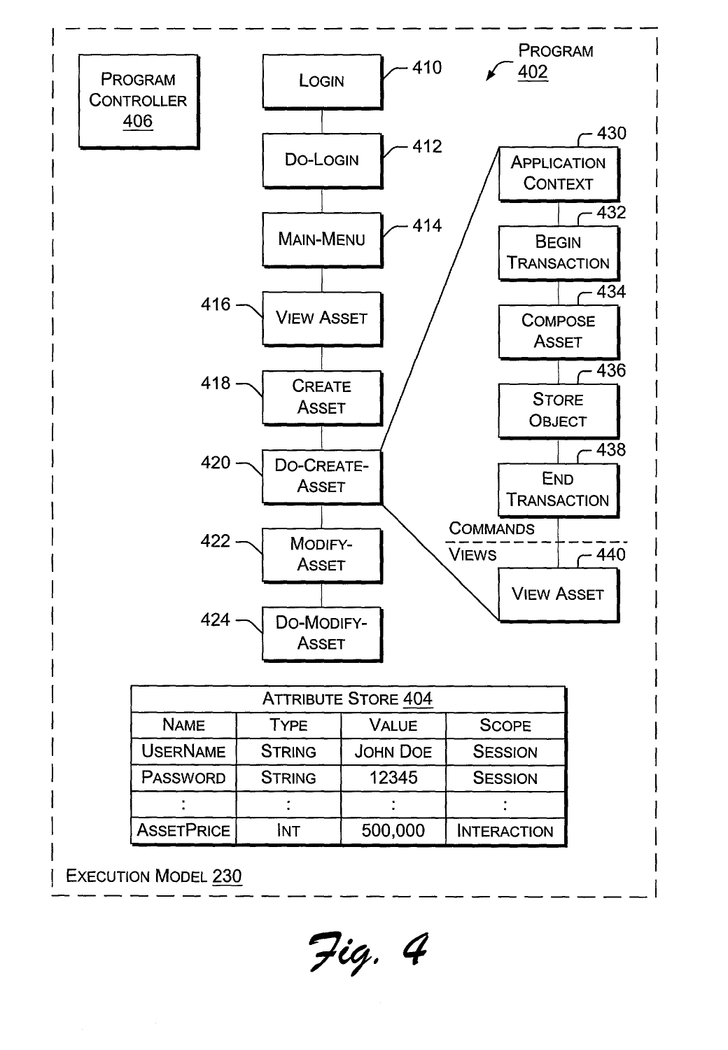

One example of an interaction-based model is a command bean model that employs multiple discrete program modules, called “Command Beans”, that are called for and executed. The command bean model is based on the “Java Bean” from Sun Microsystems, which utilizes discrete Java™ program modules. One particular execution model 230 that implements an exemplary program is described below beneath the heading “Business Logic Layer” with reference to FIGS. 4-6.

Other examples of an execution model include an action-view model and a use case model. The action-view model employs action handlers that execute code and provide a rendering to be served back to the client. The use case model maps requests to predefined UML (Unified Modeling Language) cases for processing.

The data coordination layer 206 provides an interface for the business logic layer 204 to communicate with a specific domain framework 250 implemented in the data abstraction layer 208 for a specific problem domain. In one implementation, the framework 250 utilizes a domain object model to model information flow for the problem domain. The data coordination layer 206 effectively partitions the business logic layer 204 from detailed knowledge of the domain object model as well as any understanding regarding how to obtain data from the external resources.

The data coordination layer 206 includes a set of one or more application data managers 240, utilities 242, and framework extensions 244. The application data managers 240 interface the particular domain object model in the data abstraction layer 208 into a particular application solution space of the business logic layer 204. Due to the partitioning, the execution models 230 in the business logic layer 204 are able to make calls to the application data managers 240 for specific information, without having any knowledge of the underlying domain or resources. The application data managers 240 obtain the information from the data abstraction layer 208 and return it to the execution models 230. The utilities 242 are a group of reusable, generic, and low-level code modules that developers may utilize to implement the interfaces or provide rudimentary tools for the application data managers 240.

The data abstraction layer 208 maps the domain object model to the various external resources 108. The data abstraction layer 208 contains the domain framework 250 for mapping the business logic to a specific problem domain, thereby partitioning the business applications and application managers from the underlying domain. In this manner, the domain framework 250 imposes no application-specific semantics, since it is abstracted from the application model. The domain framework 250 also does not dictate any functionality of services, as it can load any type of functionality (e.g., Java™ classes, databases, etc.) and be used to interface with third-party resources.

Extensions 244 to the domain framework 250 can be constructed to help interface the domain framework 250 to the application data managers 240. The extensions can be standardized for use across multiple different applications, and collected into a library. As such, the extensions may be pluggable and removable as desired. The extensions 244 may reside in either or both the data coordination layer 206 and the data abstraction layer 208, as represented by the block 244 straddling both layers.

The data abstraction layer 208 further includes a persistence management module 252 to manage data persistence in cooperation with the underlying data storage resources, and a bulk data access module 254 to facilitate access to data storage resources. Due to the partitioned nature of the architecture 110, the data abstraction layer 208 isolates the business logic layer 204 and the data coordination layer 206 from the underlying resources 108, allowing such mechanisms from the persistence management module 252 to be plugged into the architecture as desired to support a certain type of resource without alteration to the execution models 230 or application data managers 240.

A service layer 210 interfaces the data abstraction layer 208 and the resources 108. The service layer 210 contains service software modules for facilitating communication with specific underlying resources. Examples of service software modules include a logging service, a configuration service, a serialization service, a database service, and the like.

The presentation layer 212 contains the software elements that package and deliver the replies to the clients. It handles such tasks as choosing the content for a reply, selecting a data format, and determining a communication protocol. The presentation layer 212 also addresses the “look and feel” of the application by tailoring replies according to a brand and user-choice perspective. The presentation layer 212 is partitioned from the business logic layer 204 of the application. By separating presentation aspects from request processing, the architecture 110 enables the application to selectively render output based on the types of receiving devices without having to modify the logic source code at the business logic layer 204 for each new device. This allows a single application to provide output for many different receiving devices (e.g., web browsers, WAP devices, PDAs, etc.) and to adapt quickly to new devices that may be added in the future.

In this implementation, the presentation layer 212 is divided into two tiers: a presentation tier and a content rendering tier. The request dispatcher 224 implements the presentation tier. It selects an appropriate data type, encoding format, and protocol in which to output the content so that it can be carried over a network and rendered on the client. The request dispatcher 224 is composed of an engine 262, which resides at the framework 220 in the illustrated implementation, and multiple request dispatcher types (RDTs) 264 that accommodate many different data types, encoding formats, and protocols of the clients. Based on the client device, the engine 262 makes various decisions relating to presentation of content on the device. For example, the engine might select an appropriate data encoding format (e.g. HTML, XML, EDI, WML, etc.) for a particular client and an appropriate communication protocol (e.g. HTTP, Java™ RMI, CORBA, TCP/IP, etc.) to communicate the response to the client. The engine 262 might further decide how to construct the reply for visual appearance, such as selecting a particular layout, branding, skin, color scheme, or other customization based on the properties of the application or user preference. Based on these decisions, the engine 262 chooses one or more dispatcher types 264 to structure the reply.

A content renderer 260 forms the content rendering tier of the presentation layer 212. The renderer 260 performs any work related to outputting the content to the user. For example, it may construct the output display to accommodate an actual width of the user's display, elect to display text rather than graphics, choose a particular font, adjust the font size, determine whether the content is printable or how it should be printed, elect to present audio content rather than video content, and so on.

With the presentation layer 212 partitioned from the execution environment 202, the architecture 110 supports receiving requests in one format type and returning replies in another format type. For example, a user on a browser-based client (e.g., desktop or laptop computer) may submit a request via HTTP and the reply to that request may be returned to that user's PDA or wireless communications device using WAP. Additionally, by partitioning the presentation layer 212 from the business logic layer 204, the presentation functionality can be modified independently of the business logic to provide new or different ways to serve the content according to user preferences and client device capabilities.

The architecture 110 may include one or more other layers or modules. One example is an authentication model 270 that performs the tasks of authenticating clients and/or users prior to processing any requests. Another example is a security policy enforcement module 280 that supports the security of the application. The security enforcement module 280 can be implemented as one or more independent modules that plug into the application framework to enforce essentially any type of security rules. New application security rules can be implemented by simply plugging in a new system enforcement module 280 without modifying other layers of the architecture 110.

### GENERAL OPERATION

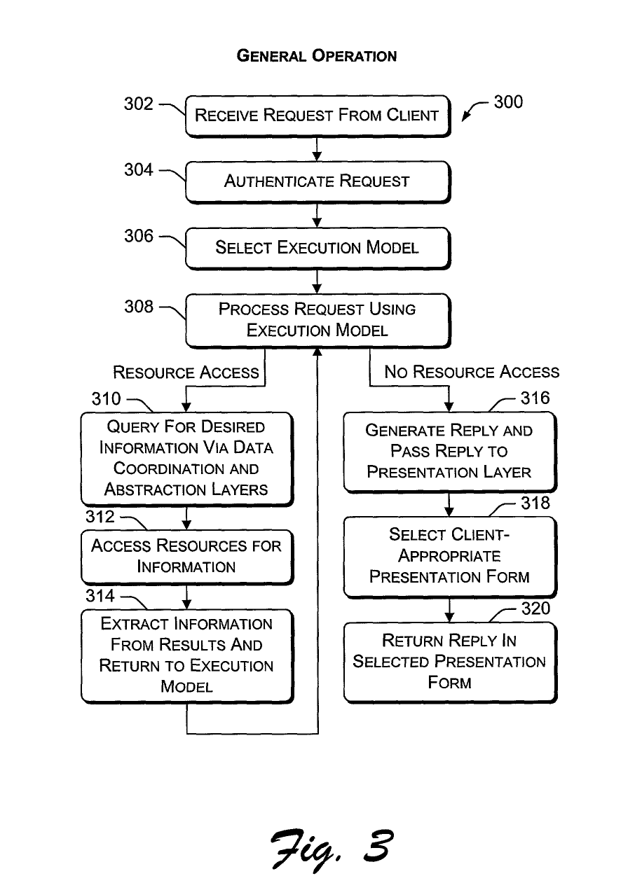

FIG. 3 shows an exemplary operation 300 of a business domain application constructed using the architecture 110 of FIGS. 1 and 2. The operation 300 is implemented as a software process of acts performed by execution of software instructions. Accordingly, the blocks illustrated in FIG. 3 represent computer-readable instructions, that when executed at the server system 106, perform the acts stipulated in the blocks.

To aid the discussion, the operation will be described in the context of asset management, wherein the architecture 110 is configured as a server application executing on the application server system 106 for an asset management domain. Additionally, for discussion purposes, suppose a user is equipped with a portable wireless communications device (e.g., a cellular phone) having a small screen with limited display capabilities and utilizing WAP to send/receive messages over a wireless cellular network. The user submits a request for information on a particular asset, such as the specification of a turbine engine or the availability of an electric pump, from the wireless communications device.

At block 302, requests from various clients are received at the execution environment layer 202. Depending on the client type, one or more adapters 228 may be involved to receive the requests and convert them to a form used internally by the application 110. In our example, the execution environment layer 202 receives the request from the wireless cellular network. An adapter 228 may be utilized to unwrap the request from its WAP-based packet for internal processing.

At block 304, the execution framework 202 may pass the request, or data extracted from the request, to the authentication model 270 for authentication of the client and/or user. If the requester is not valid, the request is denied and a service denied message (or other type of message) is returned to the client. Assuming the request is valid, the authentication model 270 returns its approval.

At block 306, the model dispatcher 222 routes the request to one or more execution models 230 in the business logic layer 204 to process the client request. In our example, the model dispatcher 222 might select selects an execution model 230 to retrieve information on the particular asset. A translator 226 may be invoked to assist in conforming the request to a form that is acceptable to the selected execution model.

At block 308, the execution model 230 begins processing the request. Suppose, for example, that the selected execution model is implemented as a command bean model in which individual code sequences, or “command beans”, perform discrete tasks. One discrete task might be to initiate a database transaction, while another discrete task might be to load information pertaining to an item in the database, and a third discrete task might be to end the transaction and return the results.

The execution model 230 may or may not need to access information maintained at an external resource. For simple requests, such as an initial logon page, the execution model 230 can prepare a reply without querying the resources 108. This is represented by the “No Resource Access” branch in FIG. 3. For other requests, such as the example request for data on a particular asset, the execution model may utilize information stored at an external resource in its preparation of a reply. This is illustrated by the “Resource Access” branch.

When the execution model 230 reaches a point where it wishes to obtain information from an external resource (e.g., geffing asset specific information from a database), the execution model calls an application data manager 240 in the data coordination layer 206 to query the desired information (i.e., block 310). The application data manager 240 communicates with the domain framework 250 in the data abstraction layer 208, which in turn maps the query to the appropriate resource and facilitates access to that resource via the service layer 210 (i.e., block 312). In our example, the domain framework is configured with an asset management domain object model that controls information flow to external resources—storage systems, inventory systems, etc.—that maintain asset information.

At block 314, results are returned from the resource and translated at the domain framework 250 back into a raw form that can be processed by the execution model 230. Continuing the asset management example, a database resource may return specification or availability data pertaining to the particular asset. This data may initially be in a format used by the database resource. The domain framework 250 extracts the raw data from the database-formatted results and passes that data back through the application data managers 240 to the execution model 230. In this manner, the execution model 230 need not understand how to communicate with the various types of resources directly, nor understand the formats employed by various resources.

At block 316, the execution model completes execution using the returned data to produce a reply to the client request. In our example, the command bean model generates a reply containing the specification or availability details pertaining to the requested asset. The execution model 230 passes the reply to the presentation layer 212 to be structured in a form that is suitable for the requesting client.

At block 318, the presentation layer 212 selects an appropriate format, data type, protocol, and so forth based on the capabilities of the client device, as well as user preferences. In the asset management example, the client device is a small wireless communication device that accepts WAP-based messages. Accordingly, the presentation layer 212 prepares a text reply that can be conveniently displayed on the small display and packages that reply in a format supported by WAP. At block 320, the presentation layer 212 transmits the reply back to the requesting client using the wireless network.

### BUSINESS LOGIC LAYER

The business logic layer 204 contains one or more execution models that define how computer programs process client requests received by the application. One exemplary execution model employs an interaction-based definition in which computer programs are individually defined by a series of one or more interaction definitions based on a request-response model. Each interaction definition includes command definitions and view definitions. A command definition defines a command whose functionality may be represented by an object that has various attributes and that provides the behavior for that command. A view definition defines a view that provides a response to a request.

Each interaction of a computer program is associated with a certain type of request. When a request is received from the model dispatcher 222, the associated interaction is identified to perform the behavior of the commands defined by that interaction. The execution model automatically instantiates an object associated with each command defined in a command definition. Prior to performing the behavior of a command, the execution model prepares the instantiated object by identifying one or more input attributes of that object (e.g., by retrieving the class definition of the object) and setting the input attributes (e.g., by invoking set methods) of the object based on the current value of the attributes in an attribute store.

After setting the attribute values, the execution model performs the behavior of the object (e.g., by invoking a perform method of the object). After the behavior is performed, the execution model extracts the output attributes of the object by retrieving the values of the output attributes (e.g., by invoking get methods of the object) and storing those values in the attribute store. Thus, the attribute store stores the output attributes of each object that are then available to set the input attributes of other objects.

The execution model may serially perform the instantiation, preparation, performance, and extraction for each command. Alternatively, the execution of commands can be performed in parallel depending on the data dependencies of the commands. Because the execution model automatically prepares an object based on the current values in the attribute store and extracts attribute values after performing the behavior of the object, a programmer does not need to explicitly specify the invocation of methods of objects (e.g., “object.setAttribute1=15″) when developing a computer program to be executed by the execution model.

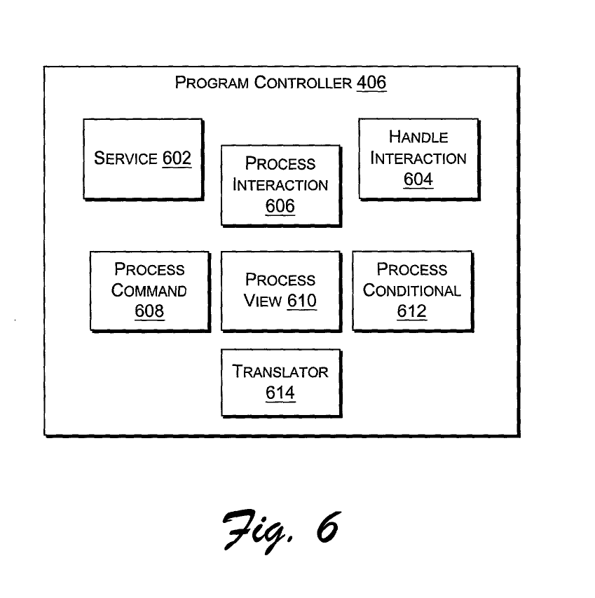

FIG. 4 shows an exemplary execution model 230 configured for an asset catalog application that allows a user to view, create, and modify information relating to assets (e.g., products) stored in an electronic catalog. The model 230 includes an asset catalog program 402, an attribute store 404, and a program controller 406. The asset catalog program 402 includes eight interactions: login 410, do-login 412, main-menu 414, view-asset 416, create-asset 418, do-create-asset 420, modify-asset 422, and do-modify-asset 424. The controller 406 executes the program 402 to perform the various interactions. One exemplary implementation of the controller is described below in more detail with reference to FIG. 6.

Upon receiving a request, the controller 406 invokes the corresponding interaction of the program 402 to perform the behavior and return a view so that subsequent requests of the program can be made. The do-create-asset interaction 420, for example, is invoked after a user specifies the values of the attributes of a new asset to be added to the asset catalog. Each interaction is defined by a series of one or more command definitions and a view definition. Each command definition defines a command (e.g., object class) that provides a certain behavior. For instance, the do-create-asset interaction 420 includes five command definitions—application context 430, begin transaction 432, compose asset 434, store object 436, and end transaction 438—and a view definition named view asset 440.

When the do-create-asset interaction 420 is invoked, the application context command 430 retrieves the current application context of the application. The application context may be used by the interaction to access certain application-wide information. The begin transaction command 432 indicates that a transaction for the asset catalog is beginning. The compose asset command 434 creates an object that identifies the value of the attributes of the asset to be added to the asset catalog. The store object command 436 stores an entry identified by the created object in the asset catalog. The end transaction command 438 indicates that the transaction to the asset catalog has ended. The view asset view 440 prepares a response (e.g., display page) to return to the user.

The attribute store 404 contains an entry for each attribute that has been defined by any interaction of the application that has been invoked. The attribute store identifies a name of the attribute, a type of the attribute, a scope of the attribute, and a current value of the attribute. For example, the last entry in the attribute store 404 has the name of “assetPrice”, with a type of “integer”, a value of “500,000”, and a scope of “interaction”. The scope of an attribute indicates the attribute's life. An attribute with the scope of “interaction” (also known as “request”) has a life only within the interaction in which it is defined. An attribute with the scope of “session” has a life only within the current session (e.g., logon session) of the application. An attribute with the scope of “application” has life throughout the duration of an application.

When the program controller 406 receives a request to create an asset (e.g., a do-create-asset request), the controller invokes the do-create-asset interaction 420. The controller first instantiates an application context object defined in the interaction command 430 and prepares the object by setting its attributes based on the current values of the attribute store 404. The controller then performs the behavior of the object by invoking a perform method of the object and extracts the attribute values of the object by getting the attribute values and storing them in the attribute store 404.

Next, the program controller 406 instantiates a begin transaction object defined by the interaction command 432 and prepares the object by setting its attribute values based on the current values of the attribute store 404. It then performs the behavior of the object by invoking a perform method of the object and extracts the attribute values of the object by getting the attribute values and storing them in the attribute store. The controller 406 repeats this process for a compose-asset object instantiated according to command 434, the store-object object instantiated according to command 436, and the end transaction object instantiated according to command 438. The controller 406 then invokes the view asset 440 to retrieve the values of the attributes of the asset from the attribute store 404 for purposes of presenting those attribute values back to the client.

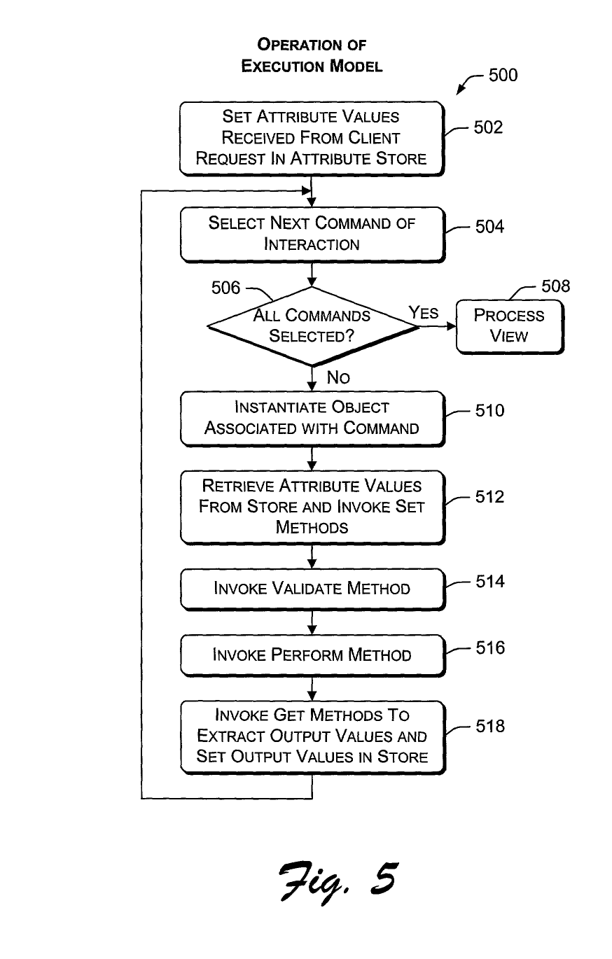

FIG. 5 shows a process 500 implemented by the program controller 406 of the execution model 230 when executing an interaction-based program, such as program 402. The process 500 is implemented in software and hence, the illustrated blocks represent computer-readable instructions, that when executed at the server system 106, perform the stated acts.

At block 502, the controller 406 sets the attribute values from the request in the attribute store 404. For example, a view-asset request may include a value for an “assetID” attribute that uniquely identifies an asset currently stored in the asset catalog. The controller then loops through each command of the interaction associated with the request. At block 504, the controller selects the next command of the interaction associated with the request, starting with the first command. If all commands have already been selected (i.e., the “yes” branch from block 506), the controller 406 processes the view defined in the view definition of the interaction and returns the response to the presentation layer 212 (i.e., block 508).

On the other hand, if not all of the commands have been selected (i.e., the “no” branch from block 506), the controller instantiates an object associated with the selected command (i.e., block 510). The object class associated with the command is specified in the command definition of the interaction. In block 512, the controller 406 prepares the object by retrieving the values of the input attributes of the object from the attribute store 404 and invoking the set methods of the object to set the values of the attributes. At block 514, the controller invokes a validate method of the object to determine whether the current values of the input attributes of the object will allow the behavior of the object to be performed correctly. If the validate method indicates that the behavior cannot be performed, the controller generates an exception and skips further processing of the commands of the interaction.

At block 516, the controller invokes the perform method of the object to perform the behavior of the object. At block 518, the controller extracts the values of the output attribute of the object by invoking the get methods of the object and setting the values of the corresponding attributes in the attribute store 404. The controller then loops to block 504 to select the next command of the interaction.

FIG. 6 shows one exemplary implementation of the controller 406 in more detail. It includes multiple components that are configured according to the request-response model where individual components receive a request and return a response. The controller 406 includes a service component 602 that is invoked to service a request message. The service component 602 stores the value of any attributes specified in the request in the attribute store 404. For example, the component may set the current value of a URL attribute as indicated by the request. Once the attribute values are stored, the service component 602 invokes a handle interaction component 604 and passes on the request. It is noted that the service component will eventually receive a response in return from the handle interaction component 604, which will then be passed back to the presentation layer 212 for construction of a reply to be returned to the client.

The handle interaction component 604 retrieves, from the program database, the interaction definition for the interaction specified in the request. The handle interaction component 604 then invokes a process interaction component 606 and passes the request, response, and the interaction definition.

The process interaction component 606 processes each command and view of the interaction and returns a response. For a given descriptor (i.e., command, view, or conditional) specified in the interaction, the process interaction component identifies the descriptor and invokes an appropriate component for processing. If the descriptor is a command, the process interaction component 606 invokes a process command component 608 to process the command of interaction. If the descriptor is a view, the process interaction component 606 invokes a process view component 610 to process the view of the interaction. If the descriptor is a conditional, the process interaction component 606 invokes a process conditional component 612 to process the conditional of the interaction.

When processing a command, the process command component 608 instantiates the object (e.g., as a “Java bean” in the Java™ environment) for the command and initializes the instantiated object by invoking an initialization method of the object. The process command component invokes a translator component 614 and passes the instantiated object to prepare the object for performing its behavior. A translator component is an object that provides a prepare method and an extract method for processing an object instantiated by the process command component to perform the command. Each command may specify the translator that is to be used for that command. If the command does not specify a translator, a default translator is used.

The translator component 614 sets the attribute values of the passed object based on the current attribute values in the attribute store 404. The translator component 614 identifies any set methods of the object based on a class definition of the object. The class definition may be retrieved from a class database or using a method provided by the object itself. When a set method is identified, the translator component identifies a value of the attribute associated with a set method of the object. The attribute store is checked to determine whether a current value for the attribute of the set method is defined. If the current value of the attribute is defined in the attribute store, the attribute value is retrieved from the attribute store, giving priority to the command definition and then to increasing scope (i.e., interaction, session, and then application). The component performs any necessary translation of the attribute value, such as converting an integer representation of the number to a string representation, and passes back the translated value. When all methods have been examined, the translator component 614 returns control to the process command component 608.

The process command component 608 may also validate the object. If valid, the component performs the behavior of the object by invoking the perform method of the object. The component once again invokes the translator and passes the object to extract the attribute values of the object and store the current attribute values in the attribute store 404.

When processing a view, the process view component 610 either invokes a target (e.g., JSP, ASP, etc.) or invokes the behavior of an object that it instantiates. If a class name is not specified in the definition of the view, the process view component 610 retrieves a target specified in the view definition and dispatches a view request to the retrieved target. Otherwise, if a class name is specified, the process view component 610 performs the behavior of an object that it instantiates. The process view component 610 retrieves a translator for the view and instantiates an object of the type specified in the view definition. The process view component 610 initializes the object and invokes the translator to prepare the object by setting the values of the attributes of the object based on the attribute store. The process view component 610 validates the object and performs the behavior of the object. The process view component 610 then returns.

When processing a conditional, the process conditional component 612 interprets a condition to identify the descriptors that should be processed. The component may interpret the condition based on the current values of the attributes in the attribute store. Then, the process conditional component 612 recursively invokes the process interaction component 606 to process the descriptors (command, view, or conditional) associated with the condition. The process conditional component 612 then returns.

One exemplary form of a program implemented as a document type definition (DTD) is illustrated in Table 1. The interactions defining the program are specified in an XML (“eXtensible Markup Language”) file.

TABLE 1

| 1. | <!ELEMENT program (translator*,command*,view*,interaction*)> | |
|---|---|---|
| 2. | <!ATTLIST program | |
| 3. | name | ID #REQUIRED |
| 4. | > | |
| 5. | | |
| 6. | <!ELEMENT translator EMPTY> | |
| 7. | <!ATTLIST translator | |
| 8. | name | ID #REQUIRED |
| 9. | class | CDATA #REQUIRED |
| 10. | default | (true\|false) “false” |
| 11. | > | |
| 12. | | |
| 13. | <!ELEMENT translator-ref EMPTY> | |
| 14. | <!ATTLIST translator-ref | |
| 15. | name | IDREF #REQUIRED |
| 16. | > | |
| 17. | | |
| 18. | <!ELEMENT command (translator-ref*, attribute*)> | |
| 19. | <!ATTLIST command | |
| 20. | name | ID #REQUIRED |
| 21. | class | CDATA #REQUIRED |
| 22. | > | |
| 23. | | |
| 24. | <!ELEMENT command-ref (attribute*)> | |
| 25. | <!ATTLIST command-ref | |
| 26. | name | IDREF #REQUIRED |
| 27. | type | (default\|finally) “default” |
| 28. | > | |
| 29. | | |
| 30. | <!ELEMENT attribute EMPTY> | |
| 31. | <!ATTLIST attribute | |
| 32. | name | ID #REQUIRED |
| 33. | value | CDATA #IMPLIED |
| 34. | get-name | CDATA #IMPLIED |
| 35. | set-name | CDATA #IMPLIED |
| 36. | scope | (application\|request\|session) “request” |
| 37. | > | |
| 38. | | |
| 39. | <!ELEMENT view> | |
| 40. | <!ATTLIST view | |
| 41. | name | ID #REQUIRED |
| 42. | target | CDATA #REQUIRED |
| 43. | type | (default\|error) “default” |
| 44. | default | (true\|false) “false” |
| 45. | > | |
| 46. | | |
| 47. | <!ELEMENT view-ref> | |
| 48. | <!ATTLIST view-ref | |
| 49. | name | IDREF #REQUIRED |
| 50. | > | |
| 51. | | |
| 52. | <!ELEMENT if (#PCDATA)> | |
| 53. | <!ELEMENT elsif (#PCDATA)> | |
| 54. | <!ELEMENT else EMPTY> | |
| 55. | <!ELEMENT conditional (if?, elsif*, else*, command-ref*, view-ref*, conditional*)> | |
| 56. | | |
| 57. | !ELEMENT interaction (command-ref*,view-ref*,conditional*)> | |
| 58. | <!ATTLIST interaction | |
| 59. | name | ID #REQUIRED |

| | |
|---|---|
| 60. | > |

Lines 1-4 define an program tag, which is the root tag of the XML file. The program tag can include translator, command, view, and interaction tags. The program tag includes a name attribute that specifies the name of the program. Lines 6-11 define a translator tag of the translator, such as translator 614. The name attribute of the translator tag is a logical name used by a command tag to specify the translator for that command. The class attribute of the translator tag identifies the class for the translator object. The default attribute of the translator tag indicates whether this translator is the default translator that is used when a command does not specify a translator.

Lines 13-16 define a translator-ref tag that is used in a command tag to refer back to the translator to be used with the command. The name attribute of the translator-ref tag identifies the name of the translator to be used by the command. Lines 18-22 define a command tag, which may include translator-ref tags and attribute tags. The translator-ref tags specify names of the translators to be used by this command and the attribute tags specify information relating to attributes of the command. The name attribute of the command tag provides the name of the command. The class attribute of the command tag provides the name of the object class that provides the behavior of the command.

Lines 24-28 define a command-ref tag that is used by an interaction tag (defined below) to specify the commands within the interaction. The command reference tag may include attribute tags. The name attribute of the command-ref tag specifies the logical name of the command as specified in a command tag. The type attribute of the command-ref tag specifies whether the command should be performed even if an exception occurs earlier in the interaction. The value of “finally.” means that the command should be performed.

Lines 30-37 define an attribute tag, which stipulates how attributes of the command are processed. The name attribute of the attribute tag specifies the name of an attribute. The value attribute of the attribute tag specifies a value for the attribute. That value is to be used when the command is invoked to override the current value for that attribute in the attribute store. The get-name attribute of the attribute tag specifies an alternate name for the attribute when getting an attribute value. The set-name attribute of the attribute tag specifies an alternate name for the attribute when setting an attribute value. The scope attribute of the attribute tag specifies whether the scope of the attribute is application, request (or interaction), or session.

Lines 39-45 define a view tag that stipulates a view. The name attribute of the view tag specifies the name of the view. The target attribute of a view tag specifies the JSP target of a view. The type attribute of the view tag specifies whether the view should be invoked when there is an error. The default attribute of the view tag specifies whether this view is the default view that is used when an interaction does not explicitly specify a view.

Lines 47-50 define a view-ref tag, which is included in interaction tags to specify that the associated view is to be included in the interaction. The name attribute of the view-ref tag specifies the name of the referenced view as indicated in a view tag. Lines 52-55 define tags used for conditional analysis of commands or views. A conditional tag may include an “if” tag, an “else if” tag, an “else” tag, a command-ref tag, a view-ref tag, and a conditional tag. The data of the “if” tag and the “else if” tag specify a condition (e.g., based on attribute values in the attribute store) that defines the commands or view that are to be conditionally performed when executing interaction.

Lines 57-60 define an interaction tag, which defines a sequence of command, view, or conditional tags of an interaction. The interaction tag may include command-ref, view-ref and conditional tags. The name attribute of the interaction tag identifies the name of the interaction. The requests passed into the execution model specify the name of the interaction to execute.

Table 2 provides an example XML file for the asset catalog program 402 illustrated in FIG. 4 and described above. Line 1 includes a program tag with the name of the program “asset catalog”. Lines 2-3 specify the default translator for the program. Lines 5-11 define the various commands associated with the program. For example, as indicated by line 7, the command named “login” is associated with the class “demo.cb.Login.” Whenever a login command is performed, an object of class “demo.cb.Login” is used to provide the behavior.

Lines 13-20 define the views of the program. For example, line 14 illustrates that the view named “view-asset” (i.e., view 440 in FIG. 4) is invoked by invoking the target named “html/view-assetjsp.” Lines 23-119 define the various interactions that compose the program. For example, lines 42-53 define the view-asset interaction 416 as including command-ref tags for each command defined in the interaction. The conditional tag at lines 47-52 defines a conditional view such that if a login user has administrator permission, the “view-asset-admin” view is invoked; otherwise, the “view-asset” view is invoked. Lines 88-90 illustrate the use of an attribute tag used within a command tag. The attribute tag indicates that the attribute named “object” is an input attribute of the command that corresponds to the attribute named “asset” in the attribute store 404.

TABLE 2

| | |
|---|---|
| 1. | <program name=“asset catalog”> |
| 2. | <translator name=“default-trans” class=“com.ge.dialect.cb.DefaultTranslator” |
| 3. | default=“true”/> |
| 4. | |
| 5. | <command name=“app-ctx” class=“demo.cb.AppCtx”/> |
| 6. | <command name=“begin-tx” class=“demo.cb.BeginTx”/> |
| 7. | <command name=“login” class=“demo.cb.Login”/> |
| 8. | <command name=“load-asset” class=“demo.cb.LoadAsset”/> |
| 9. | <command name=“compose-asset” class=“demo.cb.ComposeAsset”/> |
| 10. | <command name=“store-object” class=“demo.cb.StoreObject”/> |
| 11. | <command name=“end-tx” class=“demo.cb.EndTx”/> |
| 12. | |
| 13. | <view name=“error-view” target=“html/error.jsp” type=“error” default=“true”/> |
| 14. | <view name=“view-asset” target=“html/view-asset.jsp”/> |
| 15. | <view name=“view-asset-admin” target=“html/view-asset-admin.jsp”/> |
| 16. | <view name=“create-asset” target=“html/create-asset.jsp”/> |
| 17. | <view name=“modify-asset” target=“html/modify-asset.jsp”/> |
| 18. | <view name=“login” target=“html/login.jsp”/> |
| 19. | <view name=“login-error” target=“html/login.jsp” type=“error”/> |
| 20. | <view name=“main-menu” target=“html/main-menu.jsp”/> |
| 21. | |
| 22. | |
| 23. | <interaction name=“login”> |
| 24. | <view-ref name=“login”/> |
| 25. | </interaction> |
| 26. | |
| 27. | <interaction name=“do-login”> |
| 28. | <command-ref name=“app-ctx”/> |
| 29. | <command-ref name=“begin-tx”/> |
| 30. | <command-ref name=“login”> |
| 31. | <attribute name=“loginUser” scope=“session”/> |
| 32. | </command-ref> |
| 33. | <command-ref name=“end-tx” type=“finally”/> |
| 34. | <view-ref name=“main-menu”/> |
| 35. | <view-ref name=“login-error”/> |
| 36. | </interaction> |
| 37. | |
| 38. | <interaction name=“main-menu”> |
| 39. | <view-ref name=“main-menu”/> |
| 40. | </interaction> |
| 41. | |
| 42. | <interaction name=“view-asset”> |
| 43. | <command-refname=“app-ctx”/> |
| 44. | <command-ref name=“begin-tx”/> |
| 45. | <command-ref name=“load-asset”/> |
| 46. | <command-ref name=“end-tx” type=“finally”/> |
| 47. | <conditional> |
| 48. | <if>(loginUser != void) &amp;&amp; loginUser.hasPermission(“admin”)</if> |
| 49. | <view-ref name=“view-asset-admin”/> |
| 50. | <else/> |
| 51. | <view-ref name=“view-asset”/> |
| 52. | </conditional> |
| 53. | </interaction> |
| 54. | |
| 55. | <interaction name=“create-asset”> |
| 56. | <view-ref name=“create-asset”/> |
| 57. | </interaction> |
| 58. | |
| 59. | <interaction name=“do-create-asset”> |
| 60. | <command-ref name=“app-ctx”/> |
| 61. | <command-ref name=“begin-tx”/> |
| 62. | <command-ref name=“compose-asset”/> |
| 63. | <command-ref name=“store-object”> |
| 64. | <attribute name=“object” get-name=“asset”/> |
| 65. | </command-ref> |
| 66. | <command-ref name=“end-tx” type=“finally”/> |
| 67. | <conditional> |
| 68. | <if>(loginUser != void) &amp;&amp; loginUser.hasPermission(“admin”)</if> |
| 69. | <view-ref name=“view-asset-admin”/> |
| 70. | <else/> |
| 71. | <view-ref name=“view-asset”/> |
| 72. | </conditional> |
| 73. | </interaction> |
| 74. | |
| 75. | <interaction name=“modify-asset”> |
| 76. | <command-ref name=“app-ctx”/> |
| 77. | <command-ref name=“begin-tx”/> |
| 78. | <command-ref name=“load-asset”/> |
| 79. | <command-ref name=“end-tx” type=“finally”/> |
| 80. | <view-ref name=“modify-asset”/> |
| 81. | </interaction> |
| 82. | |
| 83. | <interaction name=“do-modify-asset”> |
| 84. | <command-ref name=“app-ctx”/> |
| 85. | <command-ref name=“begin-tx”/> |
| 86. | <command-ref name=“load-asset”/> |
| 87. | <command-ref name=“compose-asset”/> |
| 88. | <command-ref name=“store-object”> |
| 89. | <attribute name=“object” get-name=“asset”/> |
| 90. | </command-ref> |
| 91. | <command-ref name=“end-tx” type=“finally”/> |
| 92. | <conditional> |
| 93. | <if>(loginUser != void) &amp;&amp; loginUser.hasPermission(“admin”)</if> |
| 94. | <view-ref name=“view-asset-admin”/> |
| 95. | <else/> |
| 96. | <view-ref name=“view-asset”/> |
| 97. | </conditional> |
| 98. | </interaction> |
| 99. | |
| 100. | |
| 101. | <interaction name=“view-error2”> |
| 102. | <conditional> |
| 103. | <if>“A”.equals(“B”)</if> |
| 104. | <command-ref name=“begin-tx”/> |
| 105. | <command-ref name=“load-asset”/> |
| 106. | <command-ref name=“end-tx” type=“finally”/> |
| 107. | <elsif>“NEVER”.equals(“EQUAL”)</elsif> |
| 108. | <command-ref name=“load-asset”/> |
| 109. | <command-ref name=“end-tx” type=“finally”/> |
| 110. | </conditional> |
| 111. | <view-ref name=“view-asset”/> |
| 112. | </interaction> |
| 113. | |
| 114. | |
| 115. | <interaction name=“view-error”> |
| 116. | <command-ref name=“load-asset”/> |
| 117. | <command-ref name=“end-tx” type=“finally”/> |
| 118. | <view-ref name=“view-asset”/> |
| 119. | </interaction> |
| 120. | |
| 121. | </program> |

### INPUT VALIDATION

Users are able to input requests to an application via a user interface that presents one or more forms to the user, each form having one or more data input fields (e.g., text areas, user-selectable check boxes or buttons, etc.). These data inputs are predominately referred to herein as user inputs, although the inputs can alternatively come from elsewhere (e.g., from another application or component). For many forms, the application developer desires to place restrictions on the data that can be input to the fields of the form. An automatic input validation technique is used that allows forms with input fields to be automatically generated to include input validation for one or more of the input fields. Forms can be automatically generated in any of a wide variety of languages, and in one embodiment are generated as conventional pages (documents) of a conventional markup language such as the well-known HyperText Markup Language (HTML) or the well-know extensible Markup Language (XML). The form itself includes the validation code and thus performs the validation at the client (referred to as client-side validation).

The automatic input validation technique described herein can be implemented in a variety of different manners. In one implementation, the automatic input validation technique is implemented as part of an application design process during which the user interface for the application is designed. This results in the form, with the automatically generated input validation, being generated prior to distribution to customers and/or users. Alternatively, the automatic input validation technique could be implemented as part of a data input process (e.g., as part of the presentation layer 212 or the business logic layer 204 of FIG. 2). In this implementation, when a user makes a request for which the application presents a form for user input, the automatic input validation technique may be used to generate a form “on the fly” for presentation to the user.

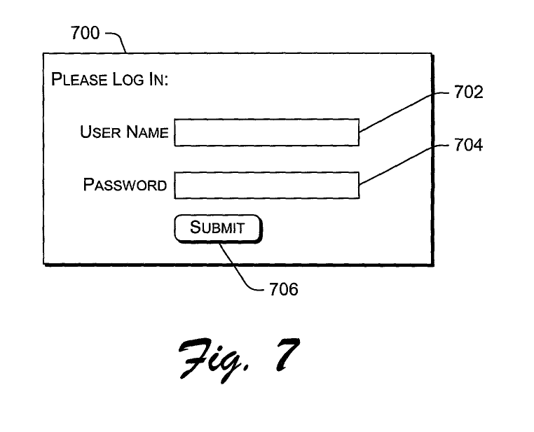

FIG. 7 illustrates an example form 700 allowing a user to log in to a system. The form 700 includes a user name field 702 into which the user can enter his or her name (or other user identifier), and a password field 704 into which the user can enter the password associated with the name entered into the field 702. Once the user has entered both, he or she can actuate the submit button 706 to proceed with the log on process.

As an example, assume that the designer of the form 700 wishes to have the user inputs into the fields 702 and 704 restricted to certain values. These restrictions may be due to processing restrictions inherent in the business logic, or alternatively simply design choices. The designer may want the user name field 702 to be a required field and have a maximum length of 32 characters, while the password field may be a required field having a minimum length of five characters. In order to place such restrictions on the fields 702 and 704, the designer of the form 700 writes a form definition (also referred to as source code) for the form (e.g., in a text markup language) using a set of custom auto-validation tags. The custom auto-validation tag for the field 702 indicates the data to be displayed (“user name”) and also identifies the desired restrictions. Similarly, the custom auto-validation tag for the field 704 indicates the data to be displayed (“password”) and also identifies the desired restrictions. The following example source code illustrates an exemplary form definition written to generate the form 700 (this form definition will be used as a basis for generating an output form definition including validation code, as discussed in more detail below):

<Custom:Form>

<Text>Please Log In:</Text>

<Custom:TextTag name=“User Name” required=“true” maxlength=“32”/>

<Custom:PasswordTag name=“Password” required=“true” minlength=“5”/>

<Custom:ButtonTag name=“Submit” type=“submit”/>

</Custom:Form>

In the above example form definition, the prefix “custom:” is used to indicate that the tag is a custom auto-validation tag (rather than a conventional tag, such as an HTML tag). The designer indicates the user name field 702 by identifying the name to be displayed on the form 700 (name=“User Name”), that data is required to be input in the field 702 (required=“true”) and that the maximum number of characters that can be input to the field is 32 (maxlength=“32”). Similarly, the designer indicates the password field 704 by identifying the name to be displayed on the form 700 (name=“Password”), that data is required to be input in the field 704 (required=“true”) and that the minimum number of characters that can be input to the field is 5 (minlength=“5”). No other information need be input by the designer for these fields to be restricted in this manner—the validation code to enforce these restrictions is automatically generated as discussed in more detail below.

It should be noted that, in the preceding example, the designer can also input additional tags without the “custom:” prefix. Such tags will not have any restrictions placed on them by the automatic generation process described herein, and will simply “fall through” into the final output form as discussed below.

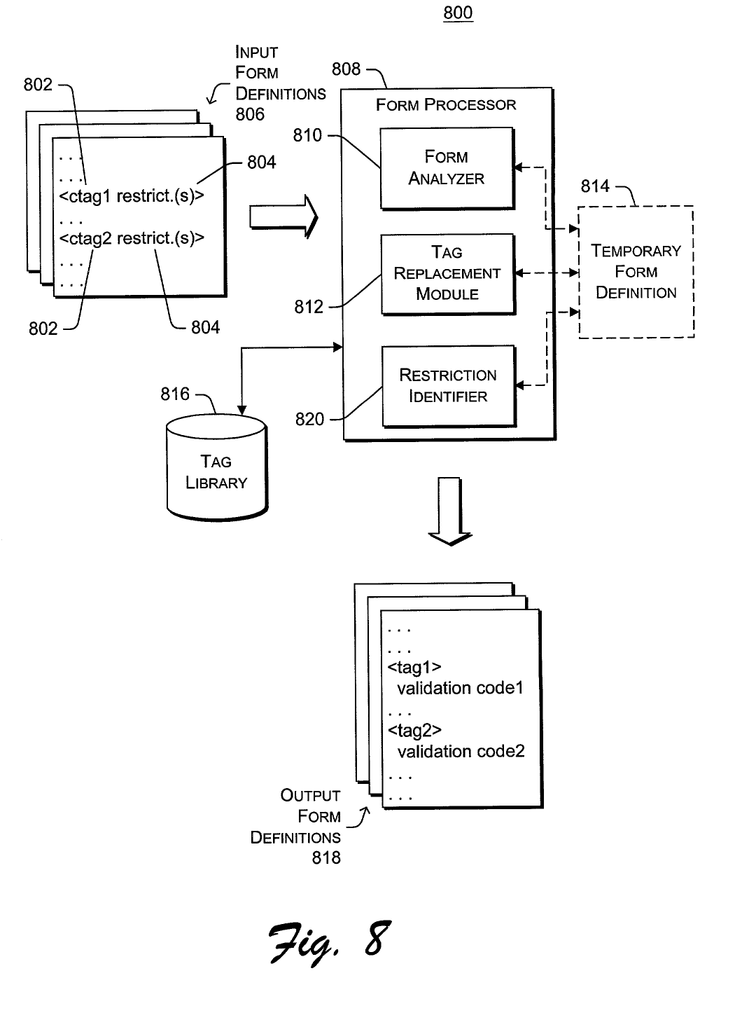

FIG. 8 illustrates an exemplary automatic form generation with input validation system 800. One or more forms are created by a designer or programmer including an identification of which fields are to have their inputs restricted and what those restrictions are. These are referred to as the “custom” fields or tags and are illustrated as “ctags” 802 and corresponding restrictions in the input form definitions 806. The input form definitions 806 are written in a source code that defines the contents of the forms. The input form definitions 806 can be written in a variety of different formats, and in one implementation is written in the JavaServer Page (JSP) format. Alternatively, the input form definitions 806 could be written in other formats, such as Active Server Page (ASP), Personal home page Hypertext Preprocessor (PHP), and so forth.

The input form definitions 806 are input to a form processor 808, which includes a form analyzer module 810 and a tag replacement module 812. The form processor 808 generates a temporary form definition 814 (e.g., in system memory) that includes two components: the first component is all of the non-custom tags, which are not altered by the form processor 808, and the second component is a replacement for each of the custom tags.

The form analyzer module 810 analyzes the input form definition 806 to identify the custom tags in the form definition 806. The form analyzer 810 adds each non-custom tag to the temporary form definition without altering the tag. The custom tags, however, are identified by the form analyzer 810 to the tag replacement module 812. The tag replacement module 812 replaces the custom tags with two components: the corresponding non-custom tag and executable code to subsequently generate the validation code for the tag. Each custom tag has a corresponding non-custom tag which provides the same functionality (except for the validation) as the custom tag. In the illustrated example above where the custom tags are identified by the prefix “custom:”, the corresponding non-custom tag is generated by dropping the prefix “custom:”. Alternatively, the corresponding non-custom tag may be generated in other manners, such as looking up the corresponding tag in a mapping table, by re-arranging characters in the custom tag in some known or agreed upon manner, and so forth.

The executable code is obtained by the tag replacement module 812 from a tag library or database 816. The tag replacement module 812 maintains a record of (e.g., is pre-programmed with) what executable code is to be inserted for a custom tag based on both the particular tag and the restrictions associated with the tag. In one implementation the executable code is Java code, although code written in other formats (e.g., JavaScript, Visual Basic for Applications (VBA), etc. could also be used).

Once all of the custom tags have been replaced (and the non-custom tags added to the temporary form), the executable code added by the tag replacement module 812 is executed. Each piece of executable code added by the tag replacement module 812 is configured to copy into the temporary form definition 814 the validation code used to validate the corresponding tag given the associated restrictions. The generation of such validation code is well-known to those skilled in the art and thus will not be discussed further. The validation code is the code that becomes part of the output form definition 818 and subsequently executes to validate user inputs. The validation code can be copied from the tag library 816, or alternatively from one or more other components (e.g., another local or remote database or computer, from a data store internal to the tag replacement module 812, etc.).

In addition to copying in the validation code for the corresponding tag, the executable code also adds in a reference to (e.g., a call to) the validation code. This reference to the validation code is associated with the corresponding tag in the temporary form and will be associated with the corresponding tag in the output form definition 818. Thus, when data is subsequently input to the form, the reference associated with the tag allows the validation code in the form to be invoked and verify the input for the corresponding field satisfies the identified restrictions. Alternatively, the form may be designed so as to automatically run the validation code rather than requiring it to be invoked by a specific reference or call to the code.

The validation code that is added to the temporary form definition 814 can be generic code or alternatively individualized code. If the validation code is generic code then it is provided with the values for the appropriate restriction(s) (e.g., the value of “32” for the maximum length of data input to a field) at run-time. This can be accomplished in a variety of manners, such as including the value(s) as a parameter when invoking the validation code. However, if the validation code is individualized code, then the executable code that copies in the validation code also alters the validation code to program in the restriction values (e.g., alter the validation code so that it checks whether the data input exceeds the value of “32”). Thus, in this situation the validation code is pre-programmed with the value (“32”) to be used for validating the input, rather than receiving the value (“32”) as a parameter when invoked.

The pieces of executable code added by the tag replacement module 812 are optionally configured with intelligence to avoid duplicate validation code in the form. If two different tags have the same restrictions or types of restrictions, and thus use the same validation code, then the pieces of executable code add that validation code only once and then add, for each of the two tags, a reference to (e.g., a call to) the single piece of validation code. For example, multiple fields may have a “required” restriction so that data must be input to the field by the user. Rather than including multiple copies of the validation code that validates that data has been input into a field, a single copy of the validation code is included in the form and each field into which data must be input has a tag that references the single copy of the validation code.

By way of another example, two different fields may have a maximum length restriction but identify two different maximum lengths (e.g., one may have a maximum length of five characters and the other a maximum length of twelve characters). If individualized validation code is being used, then the two fields have different validation code (one being pre-programmed to five characters and the other to twelve characters). However, if generic validation code is used, then only one copy of the validation code that verifies that the maximum length has not been exceeded is included in the form, and that validation code receives as an input parameter the maximum length value. The reference to (e.g., call to) this validation code associated with the tag of each field passes to the validation code the maximum length value associated with the restriction on that tag (e.g., five and twelve in the above example).

After all of the executable code added by the tag replacement module 812 has been executed, the resultant temporary form definition 814 becomes the output form definition 818. The output form definitions 818 are written in a source code that defines the contents of the forms. When displayed, the component displaying the form uses this form definition to generate an interface that can be presented to a user. The output form definition 818 is written in a conventional language (e.g., HTML or XML), and includes all of the validation code to self-validate any data input to the fields (with restrictions placed on them by the form designer). Alternatively, the output form definition 818 could be written in any public and/or proprietary language, although this may limit the use of the form (e.g., to only those environments that understand the language the form definition 818 is written in).

The following example form definition in Table 3 illustrates the source code for an exemplary output form definition 818. This source code is exemplary output source code corresponding to the example input source code discussed above, and when rendered produces form 700 of FIG. 3. Lines 1-6 define the information and data input fields displayed to the user. Line 8 identifies a JavaScript program. Lines 9-18 define various functions used to validate inputs. Lines 19-24 define the function to validate that data was input to the user name field but did not exceed 32 characters. Lines 25-30 define the function to validate that data was input to the password field and that the input was at least five characters. Lines 32-43 define variables used in the validation code. Lines 45-84 define a function for verifying that the proper number of characters (minimum and/or maximum) were input. Lines 86-88 define a function that is called (from line 5) to perform the validation when the submit input is selected by the user.

TABLE 3

| | |
|---|---|
| 1. | <FORM> |
| 2. | <TEXT>Please Log In:</TEXT> |
| 3. | <INPUT TYPE=”text” NAME=”UserName”> |
| 4. | <INPUT TYPE=”password” NAME=”Password”> |
| 5. | <INPUT TYPE=”submit” VALUE=”Submit” onSubmit=”return bValidate(this);”> |
| 6. | </FORM> |
| 7. | |
| 8. | <SCRIPT LANGUAGE=”JavaScript”> |
| 9. | function bCheckIfNotBlank(aField) { |

| | |
|---|---|
| 10. | if (!aField.value) return false; |
| 11. | else return true; |

| | |
|---|---|
| 12. | } |
| 13. | function bIsGELength(aObject, nSize) { |

| | |
|---|---|
| 14. | return aObject.value.length >= nSize; |

| | |
|---|---|
| 15. | } |
| 16. | function bIsLELength(aObject, nSize) { |

| | |
|---|---|
| 17. | return aObject.value.length <= nSize; |

| | |
|---|---|
| 18. | } |
| 19. | function bValidateTextTagUserName(aForm) { |

| | |
|---|---|
| 20. | if (!(bCheckIfNotBlank(aForm.UserName))) { |

| | |
|---|---|
| 21. | aForm.UserName.focus( ); |
| 22. | return bFormShowError(‘UserName’, null, ‘Text’, ‘Y’, null, 32, null, null, null,“”); |

| | |
|---|---|
| 23. | } |

| | |
|---|---|
| 24. | } |
| 25. | function bValidatePasswordTagTagPassword(aForm) { |

| | |
|---|---|
| 26. | if (!(bCheckIfNotBlank(aForm.Password))) { |

| | |
|---|---|
| 27. | aForm.UserName.focus( ); |
| 28. | return bFormShowError(‘Password’, null, ‘Text’, ‘Y’, 5, null, null, null, null,“”); |

| | |
|---|---|
| 29. | } |

| | |
|---|---|
| 30. | } |
| 31. | # |
| 32. | # For bFormShowError |
| 33. | # |
| 34. | # nm = Name |
| 35. | # lb = Label for field, otherwise uses name |
| 36. | # ty = Type |
| 37. | # rq = Required |
| 38. | # If ty = Text, mi = minlength, else mi = minimum value |
| 39. | # If ty = Text, ma = maxlength, else mi = maximum value |
| 40. | # vc = Valid characters |
| 41. | # ic = Invalid characters |
| 42. | # pat = Pattern |
| 43. | # pt = Prompt |
| 44. | # |
| 45. | bFormShowError=\nfunction bFormShowError(nm, lb, ty, rq, mi, ma, vc, ic, pat, pr)\n\ |
| 46. | {\n\ |
| 47. | var t = “DATA ERROR:\\n\\n”;\n\ |
| 48. | t += “An error has occurred checking the following field...\\n\\n”;\n\ |
| 49. | t += “Field: “;\n\ |
| 50. | if (lb == null \|\| lb.length == 0)\n\ |
| 51. | t += nm;\n\ |
| 52. | else\n\ |
| 53. | t += bPlainText(lb);\n\ |
| 54. | t += “\\n”;\n\ |
| 55. | if (ty != null && ty.length > 0)\n\ |

| | |
|---|---|
| 56. | t += “Type: “ + ty + “\\n”;\n\ |

| | |
|---|---|
| 57. | if (rq != null && rq.length > 0)\n\ |

| | |
|---|---|
| 58. | t += “Required: “ + rq + “\\n”;\n\ |

| | |
|---|---|
| 59. | if (mi != null)\n\ |
| 60. | {\n\ |
| 61. | if (ty == “Text”)\n\ |

| | |
|---|---|
| 62. | t += “Min length: “ + mi + “\\n”;\n\ |

| | |
|---|---|
| 63. | else\n\ |

| | |
|---|---|
| 64. | t += “Min value: “ + bPlainText(mi) + “\\n”;\n\ |

| | |
|---|---|
| 65. | }\n\ |
| 66. | if (ma != null)\n\ |
| 67. | {\n\ |
| 68. | if (ty == “Text”)\n\ |

| | |
|---|---|
| 69. | t += “Max length: “ + ma + “\\n”;\n\ |

| | |
|---|---|
| 70. | else\n\ |

| | |
|---|---|
| 71. | t += “Max value: “ + bPlainText(ma) + “\\n”;\n\ |

| | |
|---|---|
| 72. | }\n\ |
| 73. | if (vc != null && vc.length > 0)\n\ |
| 74. | t += “Allowed characters: “ + bPlainText(vc) + “\\n”;\n\ |
| 75. | if (ic != null && ic.length > 0)\n\ |
| 76. | t += “Disallowed characters: “ + bPlainText(ic) + “\\n”;\n\ |
| 77. | if (pat != null && pat.length > 0)\n\ |
| 78. | t += “Pattern(s): “ + bPlainText(pat) + “\\n”;\n\ |
| 79. | if (pr != null && pr.length > 0)\n\ |
| 80. | t += “Prompt: “ + bPlainText(pr) + “\\n”;\n\ |
| 81. | t += “\\nPlease correct the data before re-submitting the form.”\n\ |
| 82. | alert(t);\n\ |
| 83. | return false;\n\ |
| 84. | }\n |
| 85. | |
| 86. | function bValidate(this) { |

| | |
|---|---|
| 87. | bValidateTextTagUserName(this); bValidatePasswordTagPassword(this); |

| | |
|---|---|
| 88. | } |
| 89. | </SCRIPT> |

In one implementation, the form processor 808 comprises a Java compiler. The input form definitions 806 are Java Server Pages that are compiled by the Java compiler 808 into Java code, resulting in the temporary form definition 814 having replaced custom tags and inserted executable Java code. The Java code is then executed, which operates to output, as the output definitions 818, the form definition including the non-custom tags (those that were originally non-custom as well as the custom tags converted to non-custom tags), and the validation code.

Alternatively, a non-Java-oriented programming technique may be used as the form processor 808. For example, the form processor 808 may be a separate component or module (e.g., software, firmware, and/or hardware) that analyzes the form definitions 806 to identify the custom tags. These custom tags are then replaced with the corresponding HTML code, validation code, and optionally a call to the corresponding validation code.

Thus, this automatic form generation with input validation can reduce the time required for designers to develop forms having input validation. The validation code that is automatically added to the forms is initially tested before being made available to the form processor 808, so subsequent testing is not necessary regardless of how many forms it is copied to. Furthermore, the designer is alleviated of the burden of writing his or her own validation code—all that the designer needs to be concerned with is identifying what restrictions he or she desires.

A wide variety of custom tags can be used with the automatic form generation with input validation described herein, and can be used to generate forms with a wide variety of different data input fields. The following tables illustrate an exemplary set of such custom tags. These exemplary tags are described as being implemented using object-oriented programming objects, and the restrictions on tags are input as attributes for the objects. Alternatively, the tags can be implemented in other manners, such as using the restrictions as parameters when calling conventional procedures or functions.

Custom Form Tag: The custom form tag extends the HTML form tag by 10 providing automated form validation creation. This tag also supports existing HTML form tag attributes. The custom form tag is illustrated in Table 4.

TABLE 4

| | | Required/ | |
|---|---|---|---|
| Attribute | Type | Optional | Description |
| encodingType | String | optional | This attribute is used |
| | | | if creating forms with a |
| | | | different encoding type, |
| | | | used for the ENCTYPE |
| | | | attribute that gets output |
| | | | in the <FORM></FORM> tag |
| method | String | optional | This attribute determines |
| | | | which HTTP method will be |
| | | | used to pass the data to |
| | | | the program. Which method |
| | | | to use depends on the |
| | | | program that processes the |
| | | | incoming data. The valid |
| | | | values are “GET” and “POST” and |
| | | | the default value is “POST”. |
| name | String | required | This attribute represents |
| | | | the HTML form name. |
| action | String | optional | This attribute represents |
| | | | the HTML form action. A |
| | | | valid URL is used. |
| onReset | String | optional | This attribute represents |
| | | | a JavaScript function name. |
| | | | When the reset button is |
| | | | clicked, this JavaScript |
| | | | function will be executed. |
| | | | This function already |
| | | | exists on the page if this |
| | | | attribute is specified. |
| onSubmit | String | optional | This attribute represents |
| | | | a JavaScript function name. |
| | | | When the submit button is |
| | | | clicked, this JavaScript |
| | | | function will be executed. |
| | | | This function already |
| | | | exists on the page if this |
| | | | attribute is specified. |
| | | | Using this tag library, a |
| | | | validation function will |
| | | | be built automatically for |
| | | | a given form from the tags |
| | | | and attributes specified |
| | | | for each of the form |
| | | | elements. When the form |
| | | | gets submitted the |
| | | | following processing will |
| | | | occur: |
| | | | 1) The form validation |
| | | | function built |
| | | | automatically by the tag |
| | | | library will be called to |
| | | | validate the contents of |
| | | | the form. This will return |
| | | | a value of true or false. |
| | | | 2) If form validation from |
| | | | Step 1) passes, and the |
| | | | onSubmit value is not |
| | | | null, the JavaScript |
| | | | function referenced in |
| | | | onSubmit will be called. |
| | | | This function is built by |
| | | | the user and can return |
| | | | true or false depending on |
| | | | the processing that occurs |
| | | | within the function. |
| onValidate | String | optional | This attribute represents |
| | | | a JavaScript function name. |
| | | | When the submit button is |
| | | | clicked, this JavaScript |
| | | | function will be executed |
| | | | in place of the form |
| | | | validation function that |
| | | | would have been built by |
| | | | the tag library. This |
| | | | function already exists on |
| | | | the page if this attribute |
| | | | is specified. |
| | | | This function is used to |
| | | | validate the contents of |
| | | | the form and returns a |
| | | | value of true or false. |
| locale | Locale | optional | Locale used to retrieve |
| | | | localized resources |
| | | | properly. |
| target | String | optional | Target frame in which to |
| | | | post form to. |

Custom Button Tag: This tag creates a button that the user can push. The custom button tag is illustrated in Table 5.

TABLE 5

| | | Required/ | |
|---|---|---|---|
| Attribute | Type | Optional | Description |
| displayLabel | String | optional | Reserved for future use. |
| errorLabel | String | optional | Label that will be used to |
| | | | identify the form item in |
| | | | an error message |
| focusMessage | String | optional | Message to be displayed in |
| | | | the status area of the |
| | | | browser when this item |
| | | | receives focus |
| required | Boolean | optional | If this attribute is |
| | | | specified, a button must |
| | | | be pushed. The default is |
| | | | false. |
| name | String | required | Takes java.lang.String. |
| | | | The UI control name - |
| | | | field name used to |
| | | | indicate the field |
| | | | identity to the user in a |
| | | | human-readable form. |
| onClick | String | optional | This attribute represents |
| | | | a JavaScript function name. |
| | | | When the button is clicked, |
| | | | this JavaScript function |
| | | | will be executed. This |
| | | | function already exists on |
| | | | the page if this attribute |
| | | | is specified. |
| type | String | optional | Type of button, either: |
| | | | button, reset, or submit. |
| | | | The default value is |
| | | | button. |
| value | String | optional | The field value. This is |
| | | | the label used for the |
| | | | button. |
| locale | Locale | optional | Locale used to retrieve |
| | | | localized resources |
| | | | properly |

Custom Checkbox Tag: Creates a checkbox. The checkbox can be used for simple Boolean attributes, or for attributes that can take multiple values at the same time. The latter is represented by several checkbox fields with the same name and a different value attribute. Each checked checkbox generates a separate name/value pair in the submitted data, even if this results in duplicate names. The custom checkbox tag is illustrated in Table 6.

TABLE 6

| | | Required/ | |
|---|---|---|---|
| Attribute | Type | Optional | Description |
| checked | Boolean | optional | Indicates whether or not |
| | | | the checkbox is initially |
| | | | checked. Default value is |
| | | | false. |
| displayLabel | String | optional | Reserved for future use. |
| errorLabel | String | optional | Label that will be used to |
| | | | identify the form item in |
| | | | an error message |
| focusMessage | String | optional | Message to be displayed in |
| | | | the status area of the |
| | | | browser when this item |
| | | | receives focus |
| required | Boolean | optional | If this attribute is |
| | | | specified, a checkbox must |
| | | | be checked. The default is |
| | | | false. |
| name | String | required | The UI control name. |
| onClick | String | optional | This attribute represents |
| | | | a JavaScript function name. |
| | | | When the checkbox is |
| | | | clicked, this JavaScript |
| | | | function will be executed. |
| | | | This function already |
| | | | exists on the page if this |
| | | | attribute is specified. |
| onValidate | String | optional | A JavaScript function name. |
| | | | This custom JavaScript |
| | | | function is executed for |
| | | | validating this input |
| | | | field. If this option is |
| | | | specified, it is executed |
| | | | after the built in |
| | | | validation function has |
| | | | executed. The built-in |
| | | | validation function is |
| | | | created automatically |
| | | | based on the tags present |
| | | | in the form, and the |
| | | | properties set for these |
| | | | tags. |
| locale | Locale | optional | Locale used to retrieve |
| | | | localized resources |
| | | | properly |
| value | String | optional | The field value. |

Custom File Tag: This tag provides a mechanism for users to attach a file to the form's contents. For this TYPE the value the user enters is not sent to the server but this value is used as the filename of the file that is sent instead. The enctype attribute on the form will be set to enctype=“multipart/form-data” because the data sent to the server consists or more than one part. The custom file tag is illustrated in Table 7.

TABLE 7

| | | Required/ | |
|---|---|---|---|
| Attribute | Type | Optional | Description |
| displayLabel | String | optional | Reserved for future use. |
| errorLabel | String | optional | Label that will be used to |
| | | | identify the form item in |
| | | | an error message |
| focusMessage | String | optional | Message to be displayed in |
| | | | the status area of the |
| | | | browser when this item |
| | | | receives focus |
| locale | Locale | optional | Locale used to retrieve |
| | | | localized resources |
| | | | properly |
| name | String | required | The UI control name. |
| onChange | String | optional | String as an attribute. |
| | | | This attribute represents |
| | | | a JavaScript function |
| | | | name. When the focus is |
| | | | lost from the form |
| | | | element, this JavaScript |
| | | | function will be executed. |
| | | | This function must already |
| | | | exist on the page if this |
| | | | attribute is specified. |
| onValidate | String | optional | String as an attribute. |
| | | | This attribute represents |
| | | | a JavaScript function |
| | | | name. To validate this |
| | | | form element, this |
| | | | JavaScript function will |
| | | | be executed if a value is |
| | | | present for the attribute. |
| | | | This function must already |
| | | | exist on the page if this |
| | | | attribute is specified. |
| required | Boolean | optional | If this attribute is |
| | | | specified, a file must be |
| | | | attached to the form. The |
| | | | default is false. |
| value | String | optional | If this attribute is |
| | | | specified, it represents |
| | | | a default file that the |
| | | | form expects from the |
| | | | user's machine. |

Custom Hidden Tag: Hidden fields provide a mechanism for servers to store state information with a form. This will be passed back to the server when the form is submitted, using the name/value pair defined by the corresponding attributes. This is a work around for the statelessness of HTTP. The custom hidden tag is illustrated in Table 8.

TABLE 8

| | | Required/ | |
|---|---|---|---|
| Attribute | Type | Optional | Description |
| name | String | required | The UI control name. |
| onValidate | String | optional | A JavaScript function |
| | | | name. This custom |
| | | | JavaScript function is |
| | | | executed for validating |
| | | | this input field. If this |
| | | | option is specified, it is |
| | | | executed after the built |
| | | | in validation function has |
| | | | executed. The built-in |
| | | | validation function is |
| | | | created automatically |
| | | | based on the tags present |
| | | | in the form, and the |
| | | | properties set for these |
| | | | tags. |
| value | String | optional | The field value. |

Custom ImageInput Tag: Outputs the proper code to create an input button for a form from a given resource ID. The custom image input tag is illustrated in Table 9.

TABLE 9

| | | Required/ | |
|---|---|---|---|
| Attribute | Type | Optional | Description |
| imageResourceID | String | required | Image resource identifier |
| locale | Locale | optional | Locale to retrieve the |
| | | | proper image |

Custom Password Tag: Creates a single line text field which will not show the contents of the field but instead a masking character (e.g., the * character). The custom password tag is illustrated in Table 10.

TABLE 10

| | | Required/ | |
|---|---|---|---|
| Attribute | Type | Optional | Description |
| displayLength | String | optional | Specifies the display size |
| | | | for the text field. |
| displayLabel | String | optional | Reserved for future use. |
| errorLabel | String | optional | Label that will be used to |
| | | | identify the form item in |
| | | | an error message |
| focusMessage | String | optional | Message to be displayed in |
| | | | the status area of the |
| | | | browser when this item |
| | | | receives focus |
| locale | Locale | optional | Locale used to retrieve |
| | | | localized resources |
| | | | properly |
| maxLength | String | optional | The maximum length of text |
| | | | the user can enter. Is a |
| | | | valid integer value. |
| minLength | String | optional | The minimum length of text |
| | | | the user can enter. Is a |
| | | | valid integer value. |
| name | String | required | The UI control name. |
| onBlur | String | optional | This attribute represents |
| | | | a JavaScript function name. |
| | | | When the focus is lost |
| | | | from the form element, |
| | | | this JavaScript function |
| | | | will be executed. This |
| | | | function already exists on |
| | | | the page if this attribute |
| | | | is specified. |
| onValidate | String | optional | A JavaScript function name. |
| | | | This custom JavaScript |
| | | | function is executed for |
| | | | validating this input |
| | | | field. If this option is |
| | | | specified, it is executed |
| | | | after the built in |
| | | | validation function has |
| | | | executed. The built-in |
| | | | validation function is |
| | | | created automatically |
| | | | based on the tags present |
| | | | in the form, and the |
| | | | properties set for these |
| | | | tags. |
| regexp | String | optional | This is a regular |
| | | | expression that will be |
| | | | used to validate whether |
| | | | or not a given text input |
| | | | field conforms to a |
| | | | specific format given by |
| | | | the regular expression. |
| required | Boolean | optional | If this attribute is |
| | | | specified, a password must |
| | | | be entered. The default is |
| | | | false. |
| value | String | optional | The field value |

Custom Radio Tag: Creates a radio button. The radio button tag can be used for attributes which can take a single value from a set of alternatives. Each radio button field in the group is given the same name. Radio buttons require an explicit value attribute. Only the checked radio button in the group generates a name/value pair in the submitted data. The custom radio tag is illustrated in Table 11.

TABLE 11

| | | Required/ | |
|---|---|---|---|
| Attribute | Type | Optional | Description |
| displayLabel | String | optional | Reserved for future use. |
| errorLabel | String | optional | Label that will be used to |
| | | | identify the form item in |
| | | | an error message |
| focusMessage | String | optional | Message to be displayed in |
| | | | the status area of the |
| | | | browser when this item |
| | | | receives focus |
| locale | Locale | optional | Locale used to retrieve |
| | | | localized resources |
| | | | properly |
| name | String | required | The UI control name. |
| onClick | String | optional | This attribute represents |
| | | | a JavaScript function name. |
| | | | When the radio button is |
| | | | selected, this JavaScript |
| | | | function will be executed. |
| | | | This function already |
| | | | exists on the page if this |
| | | | attribute is specified. |
| onValidate | String | optional | A JavaScript function name. |
| | | | This custom JavaScript |
| | | | function is executed for |
| | | | validating this input |
| | | | field. If this option is |
| | | | specified, it is executed |
| | | | after the built in |
| | | | validation function has |
| | | | executed. The built-in |
| | | | validation function is |
| | | | created automatically |
| | | | based on the tags present |
| | | | in the form, and the |
| | | | properties set for these |
| | | | tags. |
| required | Boolean | optional | If this radio button is |
| | | | required to be selected. |
| | | | Default is false. |
| selected | Boolean | optional | If this radio button is |
| | | | initially checked. Default |
| | | | is false. |
| value | String | required | The field value |

Custom Select Tag: This tag lets you create a listbox as an input field on a form. It is valid inside the form tag. The possible choices of the listbox are created with the option tag. The custom select tag is illustrated in Table 12.

TABLE 12

| | | Required/ | |
|---|---|---|---|
| Attribute | Type | Optional | Description |
| childMenuName | String | optional | Specifies the name of |
| | | | another select list that |
| | | | exists on the page. If it |
| | | | is specified, code is |
| | | | generated automatically |
| | | | for the onChange event in |
| | | | the parent menu to |
| | | | “tie” the two select |
| | | | menus together. |
| deleteFirst | Boolean | optional | Indicates whether or not |
| | | | the first item in the menu |
| | | | specified by the |
| | | | “childmenu” |
| | | | attribute should be |
| | | | deleted when the values |
| | | | are changed in that menu. |
| displayLabel | String | optional | Reserved for future use. |
| errorLabel | String | optional | Label that will be used to |
| | | | identify the form item in |
| | | | an error message |
| focusMessage | String | optional | Message to be displayed in |
| | | | the status area of the |
| | | | browser when this item |
| | | | receives focus |
| ignoreFirst | Boolean | optional | If this optional is set to |
| | | | false and the required |
| | | | attribute is set to true, |
| | | | the SelectTag will |
| | | | generate the proper Client |
| | | | Side JavaScript (CSJS) |
| | | | validation code to make |
| | | | sure that an option, other |
| | | | than the first option in |
| | | | the list, is selected. The |
| | | | default value for this |
| | | | option is true meaning |
| | | | that the first option in |
| | | | the select list is treated |
| | | | as a valid option. |
| locale | Locale | optional | Locale used to retrieve |
| | | | localized resources |
| | | | properly |
| name | String | optional | Name of the select list |
| | | | object |
| onChange | String | optional | This attribute represents |
| | | | a JavaScript function |
| | | | name. When an item is |
| | | | selected, this JavaScript |
| | | | function will be executed. |
| | | | This function already |
| | | | exists on the page if |
| | | | this attribute is |
| | | | specified. |
| onValidate | String | optional | A JavaScript function |
| | | | name. This custom |
| | | | JavaScript function is |
| | | | executed for validating |
| | | | this input field. If this |
| | | | option is specified, it |
| | | | is executed after the |
| | | | built in validation |
| | | | function has executed. |
| | | | The built-in validation |
| | | | function is created |
| | | | automatically based on |
| | | | the tags present in the |
| | | | form, and the properties |
| | | | set for these tags. |
| required | Boolean | optional | If this select object has |
| | | | to have a value selected. |
| | | | Default is false. |
| selectType | String | optional | Either “single” or |
| | | | “multiple” to |
| | | | indicate if the select |
| | | | list can handle only a |
| | | | single or multiple |
| | | | selections, respectively. |
| size | String | optional | Number of items to |
| | | | initially display in the |
| | | | select list |
| value | String | optional | The field value |

Custom Option Tag: Used to generate an option for an option list. Typically the label is displayed to the user while the value is the data captured by a selection. The custom option tag is illustrated in Table 13.

TABLE 13

| | | Required/ | |
|---|---|---|---|
| Attribute | Type | Optional | Description |
| label | String | required | The label that will be |
| | | | used for the item. |
| name | String | optional | Not used. Instead, the |
| | | | label attribute is used as |
| | | | the text between the |
| | | | <OPTION></OPTION> tags |
| selected | Boolean | optional | Indicates if this option |
| | | | is initially selected. |
| value | String | optional | The field value. If no |
| | | | value is specified, the |
| | | | value field is replaced |
| | | | with the empty string. |

Custom Text Tag: Define a single-line text field in a form. The user can enter text inside this field. The custom text tag is illustrated in Table 14.

TABLE 14

| | | Required/ | |
|---|---|---|---|
| Attribute | Type | Optional | Description |
| displayLength | String | optional | Specifies the display |
| | | | size for the text field. |
| displayLabel | String | optional | Reserved for future use. |
| errorLabel | String | optional | Label that will be used |
| | | | to identify the form |
| | | | item in an error message |
| focusMessage | String | optional | Message to be displayed |
| | | | in the status area of |
| | | | the browser when this item |
| | | | receives focus |
| locale | Locale | optional | Locale used to retrieve |
| | | | localized resources properly |
| maxLength | String | optional | Specifies the maximum size |
| | | | for text in the text field. |
| minLength | String | optional | Specifies the maximum size |
| | | | for text in the text field. |
| maxValue | String | optional | Specifies the maximum value |
| | | | for an input field of a |
| | | | typed input such as float, |
| | | | integer, or price. |
| minValue | String | optional | Specifies the minimum value |
| | | | for an input field of a |
| | | | typed input such as float, |
| | | | integer, or price. |
| name | String | required | The UI control name |
| onBlur | String | optional | This attribute represents a |
| | | | JavaScript function name. |
| | | | When the text field loses |
| | | | focus, this JavaScript |
| | | | function will be executed. |
| | | | This function already exists |
| | | | on the page if this attribute |
| | | | is specified. |
| onValidate | String | optional | A JavaScript function name. |
| | | | This custom JavaScript |
| | | | function is executed for |
| | | | validating this input field. |
| | | | If this option is specified, |
| | | | it is executed after the |
| | | | built in validation function |
| | | | has executed. The custom |
| | | | function exists on the page. |
| | | | The built-in validation |
| | | | function is created |
| | | | automatically based on the |
| | | | tags present in the form, |
| | | | and the properties set for |
| | | | these tags. |
| regexp | String | optional | This is a regular expression |
| | | | that will be used to validate |
| | | | whether or not a given text |
| | | | input field conforms to a |
| | | | specific format given by the |
| | | | regular expression. |
| required | Boolean | optional | If this attribute is |
| | | | specified, a string must be |
| | | | entered in the input field |
| | | | box. The default is false. |
| type | String | optional | Valid values include “date”, |
| | | | “decimal”, “signeddecimal”, |
| | | | “email”, “integer”, |
| | | | “signedinteger”, “price”, |
| | | | “text”, and “year”. The |
| | | | default value is “text”. |
| value | String | optional | The field value |

Custom TextArea Tag: Define a multiline text field in a form. The user can enter text inside this field. The custom text area tag is illustrated in Table 15.

TABLE 15

| | | Required/ | |
|---|---|---|---|
| Attribute | Type | Optional | Description |
| cols | String | required | Set the number of columns the |
| | | | text window will occupy on the |
| | | | screen. |
| displayLabel | String | optional | Reserved for future use. |
| errorLabel | String | optional | Label that will be used to |
| | | | identify the form item in an |
| | | | error message |
| focusMessage | String | optional | Message to be displayed in the |
| | | | status area of the browser |
| | | | when this item receives focus |
| locale | Locale | optional | Locale used to retrieve |
| | | | localized resources properly |
| maxLength | String | optional | Specifies the maximum size for |
| | | | text in the text area. |
| minLength | String | optional | Specifies the minimum length |
| | | | for text in the text area. |
| name | String | required | UI control name. |
| onBlur | String | optional | This attribute represents a |
| | | | JavaScript function name. When |
| | | | the textarea loses focus, this |
| | | | JavaScript function will be |
| | | | executed. This function already |
| | | | exists on the page if this |
| | | | attribute is specified. |
| onValidate | String | optional | A JavaScript function name. |
| | | | This custom JavaScript function |
| | | | is executed for validating this |
| | | | input field. If this option is |
| | | | specified, it is executed after |
| | | | the built in validation function |
| | | | has executed. The custom function |
| | | | exists on the page. The built-in |
| | | | validation function is created |
| | | | automatically based on the tags |
| | | | present in the form, and the |
| | | | properties set for these tags. |
| required | Boolean | optional | If this text area is required to |
| | | | have input. Default is false. |
| rows | String | required | Set the number of rows the text |
| | | | window will show on the screen. |
| value | String | optional | The field value. |
| wrap | Boolean | optional | If text in the text area should |
| | | | wrap. The default is false. |

In one implementation, the custom tags are implemented as an object model (e.g., stored in the tag library 816). An exemplary object model to be used by the form tags to store attributes for each input type and the overall form is illustrated in the following tables. An initial object is the FormCollection object, illustrated in Table 16:

TABLE 16
FormCollection

Vector elementList (FormItem objects)
String method
String name
String action
String onReset
String onSubmit
String onValidate
formCollection(attributes);
openForm( );
closeForm( );
addItem(FormItem item);
getItem(String name);
removeItem(String name);
outputCSJSValidation( );
delete( );

The FormCollection object is extended by the FormItem object, illustrated in Table 17:

TABLE 17
FormItem (abstract)

protected String name
protected String value
outputCSJSValidation( );
outputHTML( );
delete( );
String getName( );
String getValue( );
void setName(String name);
void setValue(String value);

The FormItem object is extended by the DisplayFormItem object, illustrated in Table 18:

TABLE 18
DisplayFormItem

String errorLabel
String focusMessage
String itemType
boolean required
outputCSJSValidation( );
outputHTML( );
String geterrorLabel( );
String getFocusMessage( );
String getItemType( );
boolean getRequired( );
void seterrorLabel(String errorLabel);
void setfocusMessage(String focusMessage);
void setItemType(String itemType);
void setRequired(boolean required);

The itemType attribute in the DisplayFormItem object is one of the following: Hidden, Text, TextArea, Password, Select, Fileupload, Radio, Checkbox, Button, or Option. This identifies another object that extends the DisplayFormItem object as illustrated in the following tables.

The TextAreaItem object is illustrated in Table 19.

TABLE 19
TextAreaItem

int cols
int maxLength
int minLength
String onBlur
String onValidate
int rows
boolean wrap
outputCSJSValidation( );
outputHTML( );

The TextItem object is illustrated in Table 20.

TABLE 20
TextItem

int displayLength
String maxValue
String minValue
String maxLength
String minLength
String onBlur
String onValidate
String regexp
String type
outputCSJSValidation( );
outputHTML( );

The HiddenItem object is illustrated in Table 21.

TABLE 21
HiddenItem

String onValidate
outputHTML( );

The PasswordItem object is illustrated in Table 22.

TABLE 22
PasswordItem

int displayLength
int maxLength
int minLength
String onBlur
String onValidate
String regexp
outputCSJSValidation( );
outputHTML( );

The FileItem object is illustrated in Table 23.

TABLE 23
FileItem

String onChange
String onValidate
outputCSJSValidation( );
outputHTML( );

The ButtonItem object is illustrated in Table 24.

TABLE 24
ButtonItem

String onClick
String type
outputCSJSValidation( );
outputHTML( );

The SelectItem object is illustrated in Table 25.

TABLE 25
SelectItem

String ownedBy
boolean deleteFirst
String name
String onChange
String onValidate
String ownedBy
boolean required
String selectType
optionList: Vector of OptionItem Objects
outputCSJSValidation( );
outputHTML( );

The OptionItem object is illustrated in Table 26.

TABLE 26
OptionItem

boolean selected
outputHTML( );

The CheckboxItem object is illustrated in Table 27.

TABLE 27
CheckboxItem

boolean checked
String onClick
String onValidate
outputCSJSValidation( );
outputHTML( );

The RadioItem object is illustrated in Table 28.

TABLE 28
RadioItem

boolean selected
String onClick
String onValidate
outputCSJSValidation( );
outputHTML( );

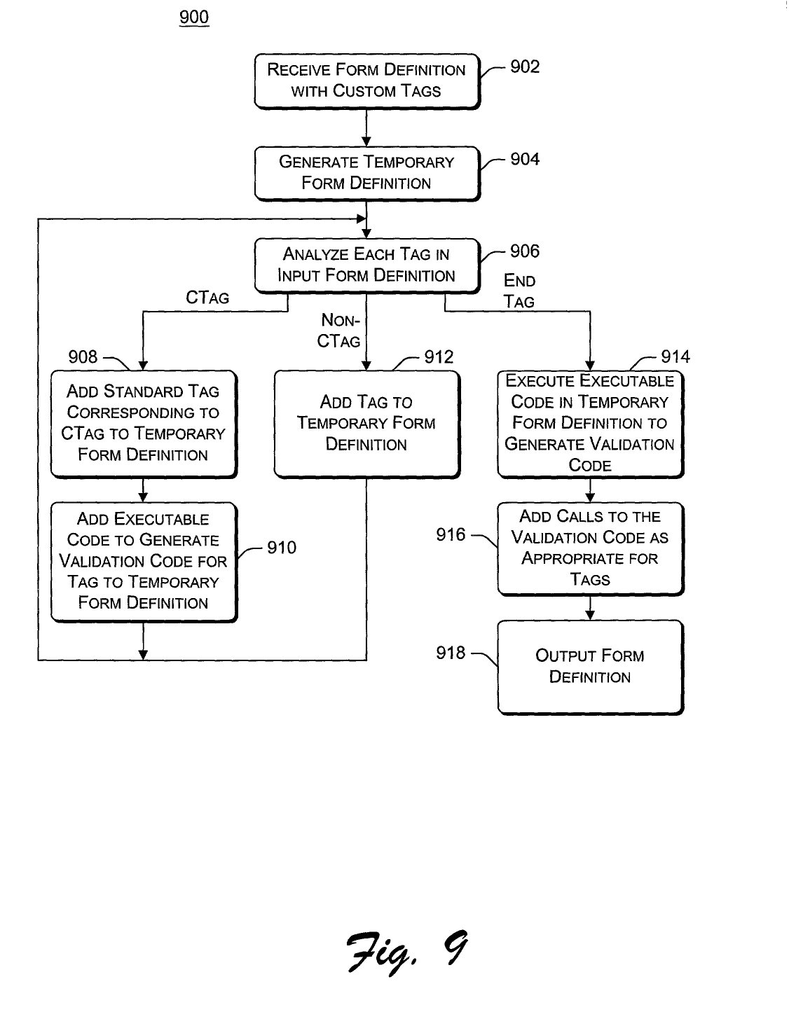

FIG. 9 is a flowchart illustrating an exemplary process 900 for automatically generating forms with input validation. The process 900 is implemented as a software process of acts performed by execution of software instructions. Accordingly, the blocks illustrated in FIG. 9 represent computer-readable instructions that when executed, perform the acts stipulated in the blocks.

At block 902 an input form definition with custom tags is received, and at block 904 a temporary form corresponding to the input form definition is generated.

At block 906 each tag in the input form definition is analyzed and a different course of action taken depending on the tag. In the process 900, three different tag types are possible and the process takes a different branch for each. The three tag types are: custom tag (the “ctag” branch), a non-custom tag (the “non-ctag” branch), and an end tag (the “end tag” branch).

At block 908 (the “ctag” branch), a standard tag corresponding to the custom tag is added to the temporary form definition. At block 910, executable code to generate validation code for the tag is added to the temporary form definition. The process then returns to block 906 to analyze another tag. In one implementation, the tags are analyzed in the order they appear in the received input form in block 902. Alternatively the tags may be analyzed in other orders (e.g., alternative tags, in reverse order, etc.).

At block 912 (the “non-ctag” branch), the tag being analyzed is added to the temporary form definition. If the tag is not a custom tag then it has not been identified as having its corresponding inputs restricted, so validation code is not generated for the tag. The process then returns to block 906 to analyze another tag.

At block 914 (the “end tag” branch), the executable code in the temporary form definition (added from block 910) is executed to generate the validation code. At block 916 calls or references to the validation code are then added to the temporary form definition as appropriate for the tags (the acts of block 916 may optionally be carried out by the executable code generating the validation code in block 914). At block 918, after all of the validation code has been added (block 914) and the calls to the validation code added (block 916), the temporary form definition is output as the output form definition.

Returning to FIG. 8, an input restriction identification module 820 may also be included in the form processor 808 to automatically identify contents for a form. These automatically identified form contents include fields to be included on the form and/or restrictions to be placed on inputs for fields of a form. The restriction identification module 820 communicates with one or more of the execution models 230 in the business logic layer 204 to identify input restrictions to fields of a form as well as possibly what fields may be needed on the form. By using the communication with the business logic layer 204, the form generation process alleviates the form designer of the burden of identifying at least some of the restrictions. The form designer can thus focus on the presentation of information and be largely de-coupled from knowledge about the business logic and input restrictions. Furthermore, changes made to the input restrictions are automatically reflected in the code generated to perform the client-side validation without requiring changes to be made by the form designer (or even knowledge of the change in the restrictions on the part of the form designer).

The restriction identification module 820 can identify restrictions on attributes from the business logic layer 204 in multiple different manners. One way in which the restriction identification module 820 can identify restrictions on input fields from the business logic layer 204 is to have the restrictions pre-programmed into the business logic layer 204. For example, the designer of business logic in the business logic layer 204 may desire to have user ID's be no greater than 32 characters in length, and passwords to be at least five characters in length. These desires can be programmed into business logic of the business logic layer 204 so that whenever the restriction identification module 820 requests an identification of restrictions for a “user ID” input field, the business logic returns an indication to the restriction identification module 820 that a maximum length restriction of 32 characters is to be placed on the user ID input field. Similarly, whenever the restriction identification module 820 requests an identification on restrictions for a “password” input field, the execution model 230 returns an indication to the restriction identification module 820 that a minimum length restriction of five characters is to be placed on the password input field. Thus, any changes to these restrictions can be made by changing the business logic and the form designer need not have any knowledge of the changes.

The business logic may also be pre-programmed with an indication of what fields need to be included in a particular form. For example, the business logic may be pre-programmed with an indication that for a log-in form (or a form corresponding to a log-in interaction or log in request), that both a user ID field and a password field are needed, as well as what restrictions are placed on the inputs to those fields. Thus, when the restriction identification module 820 requests an identification of fields and restrictions for a log-in form (or a log-in interaction or log-in request) from the business logic, the business logic returns an identification of both the fields to be included on the form as well as the restrictions (if any) on those forms to the restriction identification module 818.

Alternatively, some fields and associated restrictions may be inherent in the business logic and no special pre-programming of the business logic used to list the fields and/or associated restrictions. In this situation, the restriction identification module 820 can identify restrictions on input fields is to examine the interactions supported by the business logic of the business logic layer 204. By analyzing the interactions the restriction identification module 820 can identify attributes used by the command definitions of the interactions and identify which of these attributes are loaded by one of the command definitions from elsewhere (e.g., a resource 108) and which of these attributes are not loaded from elsewhere. The restriction identification module 818 identifies the attributes that are not loaded from elsewhere as attributes to be input by the user.

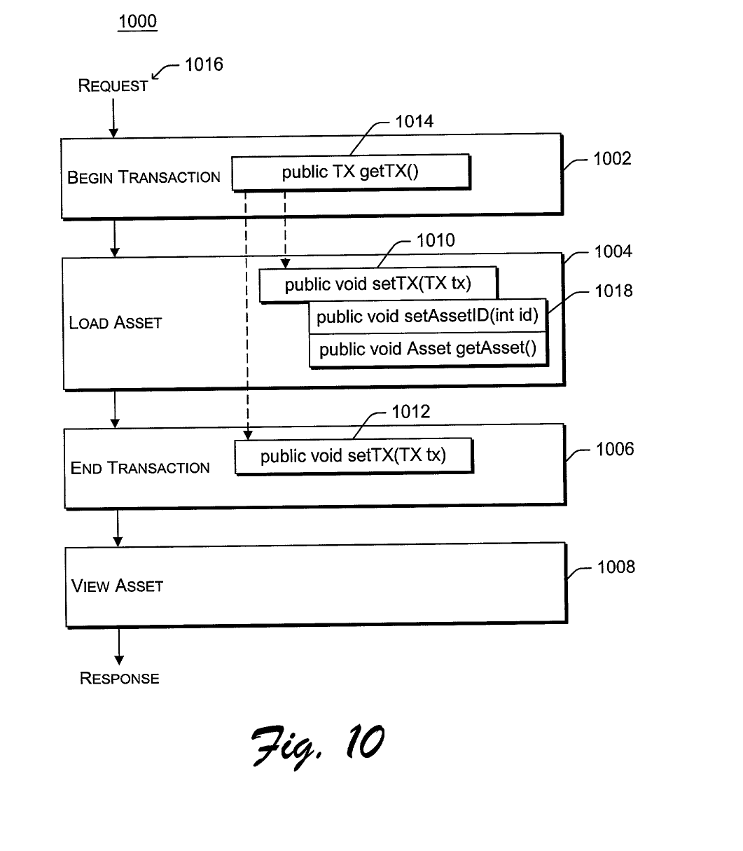

FIG. 10 illustrates an exemplary interaction 1000 that can be analyzed by the restriction identification module 820 for identification of restrictions on input fields as well as for identification of fields themselves. The interaction 1000 is a view-asset interaction including three command definitions (begin transaction 1002, load asset 1004, and end transaction 1006) and a view definition 1008. The restriction identification module 820 analyzes the interaction and identifies each of the methods or operations for setting an attribute. In the interaction 1000, the methods or operations for setting a attribute are defined as “set” methods. For each of these set methods, the restriction identification module 820 analyzes the preceding definitions in the interaction to identify whether a method or operation for getting the attribute (defined as “get” methods in the interaction 1000) exists. For each attribute identified by the restriction identification module 820 as having a set method but no preceding get method, the restriction identification module 820 identifies that attribute as needing to be input as part of the request. The restriction identification module 820 determines that the attribute is used in the interaction and that it is not obtained elsewhere by the interaction, so the restriction identification module 820 presumes that the attribute is to be obtained from a form input (e.g., a user input).

For example, a “setTX” operation exists in both the load asset definition 1004 and the end transaction definition 1006 (operations 1010 and 1012, respectively). A “getTX” operation 1014 exists in the preceding begin transaction definition 1002, so the restriction identification module 820 does not identify the “TX” attribute as being input as part of the request 1016. However, the load asset definition 1004 also includes a “setAssetID” operation 1018, and no preceding rule in the interaction 1000 includes a “getAssetID” operation. Thus, the restriction identification module 820 identifies the “AssetID” attribute as an attribute that is to be obtained from a form input (e.g., a user input), and thus a corresponding field is to be included in the form.

Restrictions on the field input (e.g., that it is a required field) can also be identified. In one implementation, any attribute used in an interaction that is not obtained elsewhere is identified as a required input field for the form. Various other restrictions for attributes can also be identified. For example, the “setAssetID” operation 1018 indicates that the attribute is an integer (the “int” portion of operation 1018). Thus, the restriction identification module 820 can identify that the input field is restricted to integer inputs.

The restriction identification module 820 can use a set of rules to analyze the business logic. These rules can be programmed in to the restriction identification module 820, or alternatively loaded into the module 820 from another source (e.g., the business logic). A wide variety of rules can be used by module 820. However, it is to be appreciated that the exact nature of such rules will vary depending on the specific business logic and the interactions included in the specific business logic. For example, the restriction identification module 820 may identify an interaction in the business logic for logging into the application. The module 820 may have a rule indicating that an attribute with the characters “password” is for a user password and has the following restrictions: it is a string, it is required, and it uses an input tag of type “password”.

In some situations, the restrictions for a data input field are not inherent in the business logic (e.g., restriction identifier 820 may not be able to readily identify that a minimum number of input characters is a restriction for a particular field). In this situation, the form processor 808 obtains an indication of this restriction in another manner (e.g., by information pre-programmed into the business logic, by custom tags on an input form, etc.).

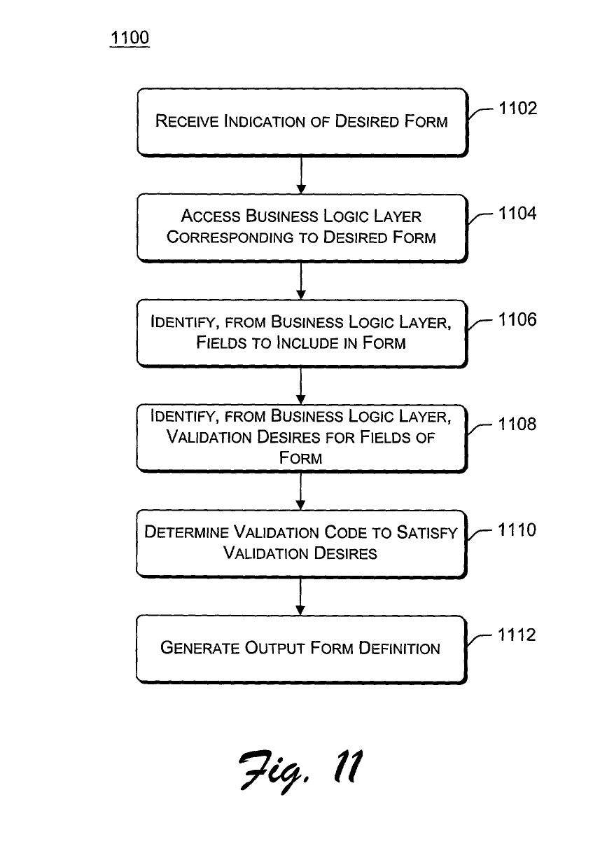

FIG. 11 is a flowchart illustrating an exemplary process 1100 for automatically identifying fields and field restrictions for forms. The process 1100 is implemented as a software process of acts performed by execution of software instructions. Accordingly, the blocks illustrated in FIG. 11 represent computer-readable instructions that when executed, perform the acts stipulated in the blocks.

At block 1102, an indication of the desired form is received. This indication identifies a type of form to be generated, such as a log-in form. The indication can be in a variety of forms, such as a request for a form by name, a request for a form corresponding to a particular interaction (e.g., a log-on interaction), etc.

At block 1104, business logic corresponding to the desired form is accessed. This business logic is, for example, one or more of the execution models 230 of the business logic layer 204 of FIG. 2.

At block 1106, fields to include in the form are identified from the business logic. As discussed above, this can be the result of analyzing the interactions and command definitions (and/or other definitions) in the accessed business logic, or alternatively by an explicit indication from the accessed business logic of the fields.

At block 1108, validation desires for fields of the form are identified from the business logic. As discussed above, this can be the result of analyzing the interactions and command definitions (and/or other definitions) in the accessed execution model(s) 230 (e.g., to identify required fields), and/or by an explicit indication from the accessed execution model(s) 230 of the validation desires.

At block 1110, validation code used to satisfy those validation desires is determined. This determination is performed by adding and subsequently executing code to generate the validation code and appropriate calls to the validation code, analogous to the discussions above regarding blocks 910, 914 and 916 of FIG. 9.

At block 1112, an output form definition is generated that includes the fields identified in block 1106 and the validation code determined in block 1110. The generated output form can then be used as-is, or alternatively altered by a programmer or other application to make a more appealing presentation of the form to the user.

Alternatively, rather than outputting a generated form, an indication of the needed fields and restrictions may be returned to a form programmer. The form programmer can then manually generate tags with associated restriction information using the custom tags discussed above. He or she can then have the form submitted to the form processor 808 for automatic generation of the form with validation code. In this situation, the validation code itself is not output by the process 1100.

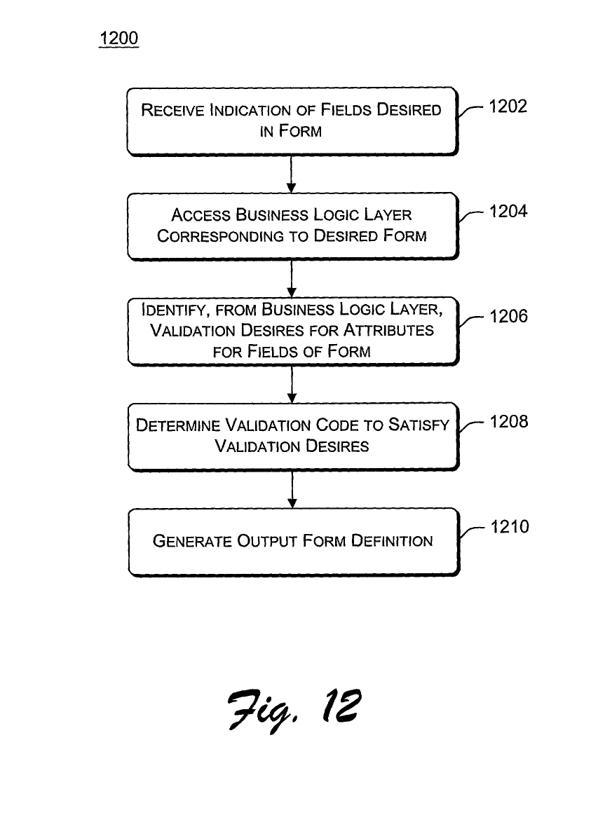

FIG. 12 is a flowchart illustrating an exemplary process 1200 for automatically identifying field restrictions for forms. The process 1200 is implemented as a software process of acts performed by execution of software instructions. Accordingly, the blocks illustrated in FIG. 12 represent computer-readable instructions that when executed, perform the acts stipulated in the blocks.

At block 1202, an indication of the fields in the desired form is received. This indication can be received in a variety of different manners, such as a listing of the fields or a form definition itself.

At block 1204, business logic corresponding to the desired form is accessed. This business logic is, for example, one or more of the execution models 230 of the business logic layer 204 of FIG. 2.

At block 1206, validation desires for fields of the form are identified from the business logic. As discussed above, this can be the result of analyzing the interactions and command definitions (and/or other definitions) in the accessed execution model(s) 230 (e.g., to identify required fields), and/or by an explicit indication from the accessed execution model(s) 230 of the validation desires.

At block 1208, validation code used to satisfy those validation desires is determined. This determination is performed by adding and subsequently executing code to generate the validation code and appropriate calls to the validation code, analogous to the discussions above regarding blocks 910, 914 and 916 of FIG. 9.

At block 1210, an output form definition is generated that includes the validation code determined in block 1208. The generated output form can then be used as-is, or alternatively altered by a programmer or, other application to make a more appealing presentation of the form to the user. Alternatively, rather than outputting a generated form, an indication of the needed restrictions may be returned to a form programmer analogous to the discussion of block 1112 above.

The automatic form generation with input validation described herein is predominately described with reference to client-side execution (e.g., client-side JavaScript code). This client-side execution refers to the form that is being filled in by the user (e.g., the form 700 of FIG. 7) including executable code. Thus, the validation code can be executed at the client where the input is taking place, rather than requiring communication back to the server. In alternate embodiments, however, some or all of the client-side executable code could be replaced with code to be executed at a server(s).

Additionally, the automatic form generation with input validation described herein is predominately described with reference to generating a new form definition based on an input form definition. Alternatively, rather than generating another form definition, the content of the input form definition could itself be changed (e.g., tags changed on the input form definition and validation code added to the input form definition).

### CONCLUSION

The discussions herein are directed primarily to software modules and components. Alternatively, the systems and processes described herein can be implemented in other manners, such as firmware or hardware, or combinations of software, firmware, and hardware. By way of example, one or more Application Specific Integrated Circuits (ASICs) or Programmable Logic Devices (PLDs) could be configured to implement selected components or modules discussed herein.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. One or more computer-readable media comprising computer-executable instructions that, when executed, direct a processor to perform acts comprising:
identifying a field on a form and one or more restrictions on an input to the field;
identifying validation code that, when executed, validates that the input conforms to the one or more restrictions; and
adding, to a form definition that includes the field, the identified validation code.

2. One or more computer-readable media as recited in claim 1, wherein the computer-executable instructions further direct the processor to perform acts comprising:
adding, to the form definition, a reference to the identified validation code in the form that, when executed by another processor, causes the other processor to execute the identified validation code.

3. One or more computer-readable media as recited in claim 1, wherein the identifying validation code comprises identifying pre-defined validation code.

4. One or more computer-readable media as recited in claim 1, wherein the form that defines the field includes a tag corresponding to the field.

5. One or more computer-readable media as recited in claim 1, wherein the input comprises a user input.

6. One or more computer-readable media as recited in claim 1, wherein the identifying validation code comprises:
identifying a custom tag corresponding to the field, wherein the custom tag includes an indication of one or more attributes, and wherein each of the one or more attributes includes a value indicating what input corresponding to the field is to be restricted to; and
identifying, from a plurality of pieces of validation code, the validation code corresponding to the one or more attributes of the custom tag.

7. A computerized method comprising:
identifying one or more custom tags to be included in a form definition, wherein each custom tag has one or more associated input restrictions; and
automatically generating the form definition by,
converting each custom tag to another tag format, and
adding, for each converted tag, a validation code that, when executed, verifies that an input corresponding to the tag satisfies the one or more input restrictions.

8. A method as recited in claim 7, wherein the other tag format comprises a publicly known standard tag format.

9. A method as recited in claim 7, wherein the identifying further comprises identifying one or more tags already in the other tag format, and wherein the automatically generating further comprises adding each of the one or more tags already in the other format to the form definition.

10. A method as recited in claim 7, wherein the form definition is in a text markup language.

11. A method as recited in claim 7, wherein the input comprises a user input.

12. A method as recited in claim 7, wherein the form definition comprises a HyperText Markup Language (HTML) document.

13. A method as recited in claim 7, wherein the form definition comprises an eXtensible Markup Language (XML) document.

14. A method as recited in claim 7, wherein the input restrictions include one or more of the following: whether input corresponding to the tag is required, a maximum length of the input corresponding to the tag, and a minimum length of the input corresponding to the tag.

15. A method as recited in claim 7, wherein one of the one or more associated input restrictions identifies additional validation code to be executed.

16. A method as recited in claim 7, wherein each input restriction includes an indication of the input restriction and a corresponding value that input corresponding to the tag is to be restricted to.

17. A method as recited in claim 7, wherein the automatically generating further comprises:
generating a temporary form definition;
adding each converted tag to the temporary form definition;
adding execution code to the temporary form definition;
executing, after all of the custom tags to be included in the form definition have been identified, the execution code to add the validation code to the temporary form definition; and
outputting, as the form definition, the temporary form definition.

18. A method as recited in claim 17, wherein the executing further comprises adding, to the temporary form, a call to invoke the added validation code.

19. A computerized method comprising:
identifying one or more desired fields to be included on a form via which data can be input; and
automatically adding validation code to source code of the form, wherein the validation code is based at least in part on the one or more desired fields and one or more desired input restrictions associated with the one or more desired fields.

20. A method as recited in claim 19, wherein the identifying comprises identifying a custom tag corresponding to each of the one or more desired fields, wherein each custom tag has one or more validation attributes, and wherein each validation attribute includes an indication of the attribute and a corresponding value that input corresponding to the custom tag is to be restricted to.

21. A method as recited in claim 19, wherein the input comprises a user input.

22. A method as recited in claim 19, wherein the automatically adding comprises:
generating a temporary form definition;
adding execution code to the temporary form definition;
executing the execution code to add the validation code to the temporary form definition; and
outputting, as the source code, the temporary form definition.

23. A system comprising:
a form analyzer configured to identify one or more custom tags associated with a form; and
a tag replacement module, coupled to the form analyzer, configured to replace each of the one or more custom tags with another tag, and further to add, to a form definition, for each of the one or more custom tags, validation code to validate subsequent inputs to a field corresponding to the tag.

24. A system as recited in claim 23, wherein the inputs comprise user inputs.

25. A system as recited in claim 23, wherein the system comprises a compiler.

26. A system as recited in claim 23, wherein each of the other tags with which the tag replacement module replaces a custom tag is a HyperText Markup Language (HTML) tag.

27. A system as recited in claim 23, wherein the tag replacement module is further configured to add a reference to the added validation code.

28. A system as recited in claim 23, wherein the tag replacement module is further configured to generate a new document corresponding to the page, to replace each of the one or more custom tags with another tag by adding the other tag to the new document, and to add validation code by adding the validation code to the new document.

29. A system as recited in claim 23, wherein a plurality of the one or more custom tags have restrictions corresponding to the same validation code, and wherein the tag replacement module is further configured to add the same validation code only once.

30. A system as recited in claim 23, further comprising a tag library, coupled to the tag replacement module, to store the validation code.

31. A system as recited in claim 30, wherein the tag library is further to store an identification of the one or more custom tags.

32. A method comprising:
receiving a form definition including one or more custom tags, wherein each custom tag corresponds to a data input, and wherein each custom tag has one or more associated input restrictions; and
for each of the one or more custom tags,
identifying a replacement non-custom tag,
adding the identified replacement non-custom tag to a new form definition,
identifying validation code that, when executed based on an input corresponding to the tag, validates whether the associated input restrictions are satisfied, and
adding the identified validation code to the new form definition.

33. A method as recited in claim 32, wherein the method further comprises, for each of the one or more custom tags:
adding, to the new form definition, a reference to invoke the added validation code.

34. A method as recited in claim 32, wherein the receiving further comprises receiving, as part of the form definition, one or more non-custom tags, and wherein the method further comprises adding each of the non-custom tags to the new form definition.

35. A method as recited in claim 32, wherein the data input comprises data input by a user.

36. A method as recited in claim 32, wherein each input custom tag includes one or more attributes that identify the one or more associated input restrictions, and wherein each of the one or more attributes includes an indication of the attribute and a corresponding value that data input corresponding to the tag is to be restricted to.

37. A method as recited in claim 32, wherein adding the identified validation code comprises:
adding execution code to the new form definition; and
or: executing the execution code to add the identified validation code to the new form definition.

38. A data structure comprising:
a first portion identifying an input field for a form; and
a second portion identifying one or more restrictions on inputs to the input field, and further identifying validation code to be added to a page to enforce the one or more restrictions on inputs to the input field.

39. A data structure as recited in claim 38, wherein the data structure comprises a text markup language document.

40. A data structure as recited in claim 38, wherein the first portion further identifies a type of the input field.

41. A data structure as recited in claim 38, wherein the second portion comprises a set of one or more attributes and, for each attribute, an associated value for the attribute.

42. A data structure as recited in claim 38, wherein the input field is for user-input of data.
